(19) United States
(12) Patent Application Publication
(10) Pub. No.: US 2025/0093102 A1
(43) Pub. Date: Mar. 20, 2025

(54) MANAGEMENT OF VARIABLES OF A KILN

(71) Applicant: OXBOW CALCINING LLC, West Palm Beach, FL (US)

(72) Inventors: Ryan Glander, Houston, TX (US); Ryan Piscopo, Baton Rouge, LA (US); James Olson, Conroe, TX (US); Randell Gillum, Duson, LA (US); Monika Modi, Boca Raton, FL (US)

(73) Assignee: OXBOW CALCINING LLC, West Palm Beach, FL (US)

(21) Appl. No.: 18/889,611

(22) Filed: Sep. 19, 2024

Related U.S. Application Data
(60) Provisional application No. 63/539,168, filed on Sep. 19, 2023.

(51) Int. Cl. F27B 7/42; F27D 19/00

(52) U.S. Cl. CPC F27B 7/42; F27D 19/00; F27D 2019/0006

(57) ABSTRACT

Systems, methods, and computer-readable media for managing variables of a kiln are provided (e.g., to determine a kiln output product state of a kiln and to manage a mode of operation of the kiln apparatus or an associated subsystem based on the determined kiln output product state). Any suitable kiln model(s) may be trained and utilized in conjunction with any suitable kiln apparatus monitoring data that may be indicative of any suitable characteristic(s) of any suitable kiln apparatus(es) and/or any suitable kiln material monitoring data that may be indicative of any suitable characteristic(s) of any suitable kiln material(s) of the kiln apparatus(es) and/or any suitable external environment monitoring data that may be indicative of any suitable characteristic(s) of any suitable environment(s) external to the kiln apparatus(es) in order to predict or otherwise determine automatically a kiln output product state of a kiln in a particular environment.

### CROSS-REFERENCE TO RELATED APPLICATION(S)

This application claims the benefit of prior filed U.S. Provisional Patent Application No. 63/539,168, filed Sep. 19, 2023, which is hereby incorporated by reference herein in its entirety.

### COPYRIGHT NOTICE

At least a portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyright rights whatsoever.

### TECHNICAL FIELD

This disclosure relates to the management of variables of a kiln and, more particularly, to the management of variables of a kiln with a trained kiln model.

### BACKGROUND OF THE DISCLOSURE

A rotary kiln (e.g., a rotary calcining kiln) may be provided with one or more measurement components (e.g., temperature sensors, airflow meters, etc.) that may be utilized for attempting to determine characteristics of the kiln. However, the data provided by such measurement components is often insufficient on its own to enable a reliable determination of the product qualities that may be generated by the kiln.

### SUMMARY OF THE DISCLOSURE

This document describes systems, methods, and computer-readable media for managing variables of a kiln.

For example, a method for managing a kiln system using a kiln management model custodian system is provided that may include initially configuring, at the kiln management model custodian system, a learning engine for the kiln system, receiving, at the kiln management model custodian system from the kiln system, monitored system data for at least one monitored system data category for a kiln experience and a kiln output product state for the kiln experience, training, at the kiln management model custodian system, the learning engine using the received monitored system data and the received kiln output product state, accessing, at the kiln management model custodian system, monitored system data for the at least one monitored system data category for another kiln experience, determining a kiln output product state for the other kiln experience, using the learning engine for the kiln system at the kiln management model custodian system, with the accessed monitored system data for the other kiln experience, and, when the determined kiln output product state for the other kiln experience satisfies a condition, generating, with the kiln management model custodian system, control data associated with the satisfied condition.

As another example, a kiln management model custodian system is provided that may include a communications component, and a processor operative to initially configure a learning engine for the kiln system, receive, from the kiln system, monitored system data for at least one monitored system data category for a kiln experience and a kiln output product state for the kiln experience, train the learning engine using the received monitored system data and the received kiln output product state, access monitored system data for the at least one monitored system data category for another kiln experience, determine a kiln output product state for the other kiln experience, using the learning engine for the kiln system, with the accessed monitored system data for the other kiln experience, and, when the determined kiln output product state for the other kiln experience satisfies a condition, generate control data associated with the satisfied condition.

As yet another example, a non-transitory computer-readable storage medium storing at least one program including instructions is provided, which, when executed may initially configure a learning engine for a kiln system, receive, from the kiln system, monitored system data for at least one monitored system data category for a kiln experience and a kiln output product state for the kiln experience, train the learning engine using the received monitored system data and the received kiln output product state, access monitored system data for the at least one monitored system data category for another kiln experience, determine a kiln output product state for the other kiln experience, using the learning engine for the kiln system, with the accessed monitored system data for the other kiln experience, and, when the determined kiln output product state for the other kiln experience satisfies a condition, generate control data associated with the satisfied condition.

This Summary is provided to summarize some example embodiments, so as to provide a basic understanding of some aspects of the subject matter described in this document. Accordingly, it will be appreciated that the features described in this Summary are only examples and should not be construed to narrow the scope or spirit of the subject matter described herein in any way. Unless otherwise stated, features described in the context of one example may be combined or used with features described in the context of one or more other examples. Other features, aspects, and advantages of the subject matter described herein will become apparent from the following Detailed Description, Figures, and Claims.

### BRIEF DESCRIPTION OF THE DRAWINGS

The discussion below makes reference to the following drawings, in which like reference characters may refer to like parts throughout, and in which:

FIG. 1 is a schematic view of an illustrative system for managing variables of a kiln with a trained kiln model of the disclosure, in accordance with one or more implementations;

FIG. 1A is a more detailed schematic view of a subsystem of the system of FIG. 1, in accordance with one or more implementations;

FIG. 1B is a more detailed schematic view of an illustrative example of the system of FIG. 1, in accordance with one or more implementations;

FIG. 2 is a schematic view of exemplary kiln apparatus of the system of FIGS. 1, 1A, and 1B, in accordance with one or more implementations;

FIG. 3 is a schematic view of an illustrative portion of the system of FIGS. 1, 1A, 1B, and 2, in accordance with one or more implementations; and

FIG. 4 is a flowchart of an illustrative process for managing variables of a kiln, in accordance with one or more implementations.

### DETAILED DESCRIPTION OF THE DISCLOSURE

Systems, methods, and computer-readable media may be provided to manage variables of a kiln apparatus (e.g., to determine a kiln output product state of a kiln and to manage a mode of operation of the kiln apparatus or an associated subsystem based on the determined kiln output product state). Any suitable kiln model(s) (e.g., neural network(s) and/or learning engine(s), etc.) may be trained and utilized in conjunction with any suitable kiln apparatus monitoring data that may be indicative of any suitable characteristic(s) of any suitable kiln apparatus(es) (e.g., raw feed material weigh belt rate, conditioned material weigh belt rate, calcined material weigh belt rate, natural gas flow rate, air flow rate(s), kiln rotation speed, blower air flow rate, quench water flow rate, stack opacity, firing hood draft, burn zone temperature, stack damper position, etc.) and/or any suitable kiln material monitoring data that may be indicative of any suitable characteristic(s) of any suitable kiln material(s) of the kiln apparatus(es) (e.g., raw feed material quality, electrical resistivity of calcined material, real density of calcined material, etc.) and/or any suitable external environment monitoring data that may be indicative of any suitable characteristic(s) of any suitable environment(s) external to the kiln apparatus(es) (e.g., ambient humidity, ambient temperature, current wind speed, etc.) in order to predict or otherwise determine automatically a kiln output product state of a kiln in a particular environment. Such a kiln output product state may be analyzed with respect to particular conditions or regulations or thresholds in order to generate any suitable control data for controlling any suitable functionality of any suitable assembly of the kiln apparatus(es) or of any subsystem associated with the kiln apparatus(es) or with the environment(s) thereof (e.g., for adjusting a user interface presentation to an operator of a kiln apparatus (e.g., to provide a predicted kiln output product state) and/or for adjusting an output of any suitable controlling module(s) of the kiln apparatus(es) or related subsystem(s) for adjusting the operation of the kiln subsystem(s) (e.g., for adjusting the rotation speed, natural gas flow rate, and/or the like of a kiln apparatus for affecting a real density, electrical resistivity, and/or the like of a calcined material output by the kiln apparatus and/or for minimizing the use of natural gas/fuel source and/or material loss)).

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

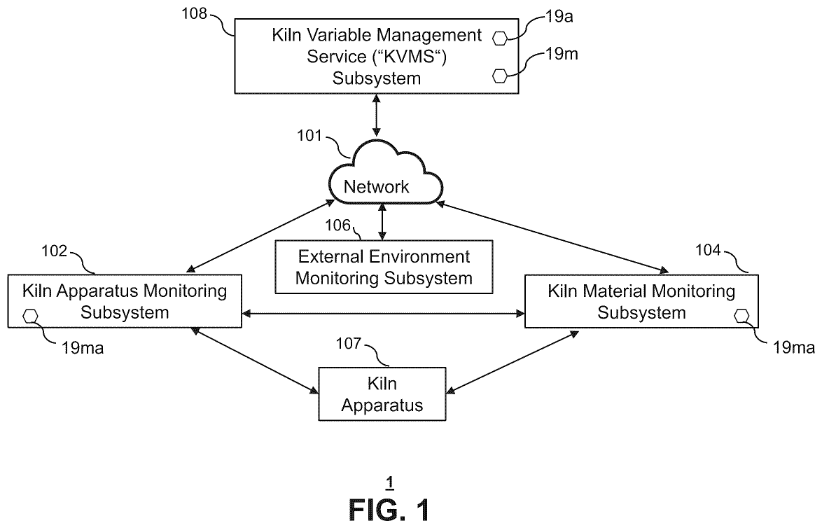

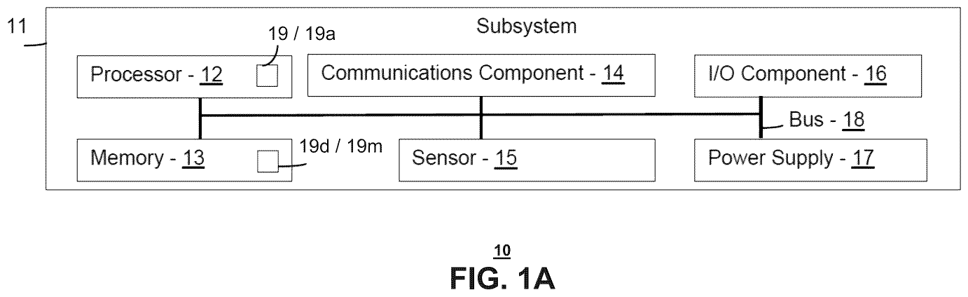

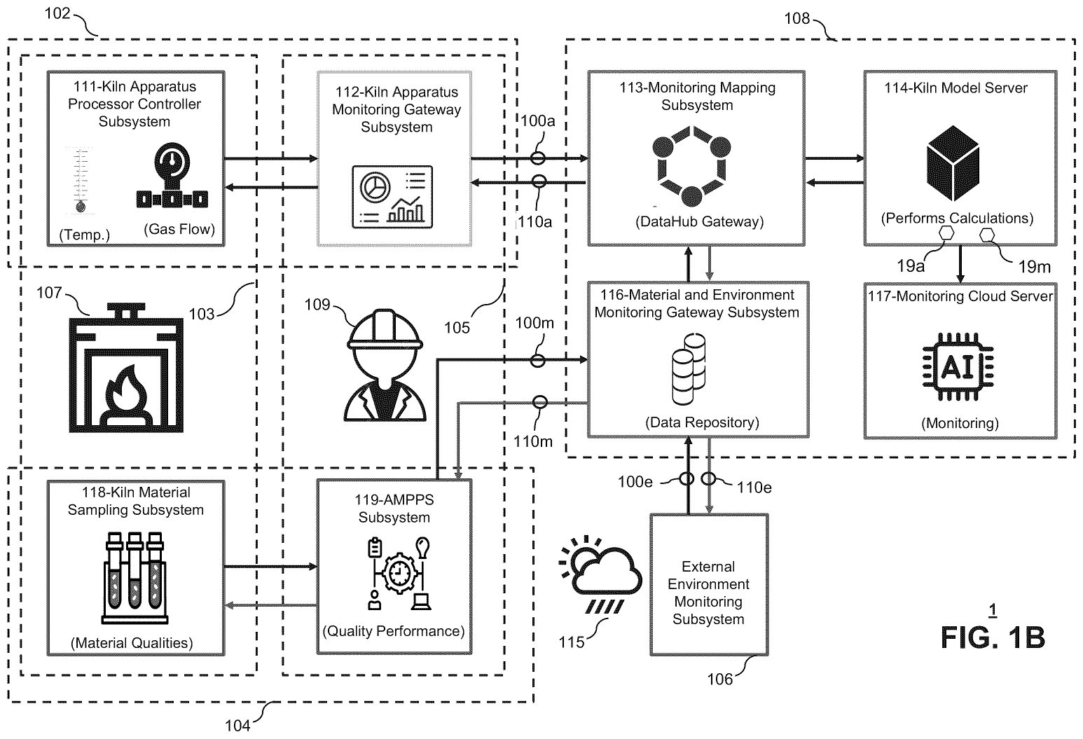

FIG. 1 is a schematic view of an illustrative system 1 in which managing variables of a kiln may be facilitated utilizing one or more kiln apparatuses, one or more kiln apparatus monitoring subsystems, one or more kiln material monitoring subsystems, one or more external environment monitoring subsystems, and/or one or more kiln variable management service (“KVMS”) subsystems. For example, as shown in FIG. 1, system 1 may include at least one kiln apparatus monitoring subsystem 102, at least one kiln material monitoring subsystem 104, at least one external environment monitoring subsystem 106, at least one kiln apparatus 107, at least one KVMS subsystem 108, and at least one communications network 101 through which any two or more subsystems of system 1 may communicate.

A kiln apparatus 107 may be any suitable pyroprocessing device (e.g., a rotary kiln) that may be configured to raise any suitable material(s) to a high temperature (e.g., a calcining kiln that may be configured to carryout calcination of any suitable raw material (e.g., raw “green” petroleum coke) by heating the material to high temperatures (e.g., 1200-1350° Celsius) for removing excess moisture, extracting all remaining hydrocarbons, and modifying the crystalline structure of the material, which may result in a denser and more electrically conductive product when cooled (e.g., calcined petroleum coke), which may be used for any suitable purpose (e.g., to make anodes for the aluminium, steel, and/or titanium smelting industries)). Calcination may refer to thermal treatment of a solid chemical compound (e.g., mixed carbonate ores) whereby the compound may be raised to a high temperature without melting under restricted supply of ambient oxygen (e.g., gaseous O2 fraction of air), generally for the purpose of removing impurities or volatile substances and/or to incur thermal decomposition.

A kiln apparatus monitoring subsystem 102 may be any suitable subsystem that may be configured to (i) provide and/or control any suitable kiln apparatus monitoring module(s) (e.g., sensors, etc.) that may be operative to detect any suitable kiln apparatus monitoring data (e.g., data 100a of FIG. 1B) that may be indicative of any suitable characteristic(s) of kiln apparatus 107 (e.g., raw feed material weigh belt rate, conditioned material weigh belt rate, calcined material weigh belt rate, natural gas flow rate, air flow rate(s), kiln rotation speed, blower air flow rate, quench water flow rate, stack opacity, firing hood draft, burn zone temperature, stack damper position, etc.) and/or (ii) communicate such kiln apparatus monitoring data to any suitable other subsystems (e.g., a KVMS subsystem (e.g., if one or more kiln models are not maintained by subsystem 102 itself)) and/or (iii) receive kiln apparatus controlling data (e.g., data 110a of FIG. 1B) from any suitable other subsystems (e.g., a KVMS subsystem (e.g., if one or more kiln models are not maintained by subsystem 102 itself)) and/or (iv) provide and/or control any suitable kiln apparatus controlling module(s) (e.g., actuators, motors, valves, etc.) that may be operative to adjust any suitable characteristic(s) of kiln apparatus 107 (e.g., raw feed material weigh belt rate, conditioned material weigh belt rate, calcined material weigh belt rate, natural gas flow rate, air flow rate(s), kiln rotation speed, blower air flow rate, quench water flow rate, stack opacity, firing hood draft, burn zone temperature, stack damper position, etc.) based on any suitable kiln apparatus controlling data.

A kiln material monitoring subsystem 104 may be any suitable subsystem that may be configured to (i) provide and/or control any suitable kiln material monitoring module(s) (e.g., sensors, lab equipment (e.g., pycnometers or similar devices (e.g., for measuring real density), Ohmmeters or similar devices (e.g., for measuring electrical resistivity), X-Ray fluorescence (“XRF”) equipment or similar devices (e.g., for measuring Vanadium), mass balances and ovens (e.g., for calculations of moisture percentages), etc.), etc.) that may be operative to detect any suitable kiln material monitoring data (e.g., data 100m of FIG. 1B) that may be indicative of any suitable characteristic(s) of any suitable material(s) used by and/or produced by kiln apparatus 107 (e.g., raw feed material quality of raw feed material (e.g., Vanadium (e.g., parts per million), volatile matter (e.g., percentage of raw coke material), moisture (e.g., percentage of raw coke material), etc.), electrical resistivity of calcined material, real density of calcined material, yield (e.g., a mathematical calculation of the weight of the calcined material divided by the weight of the raw material, subtracting out measured moisture), etc.) and/or (ii) communicate such kiln material monitoring data to any suitable other subsystems (e.g., a KVMS subsystem (e.g., if one or more kiln models are not maintained by subsystem 104 itself)) and/or (iii) receive kiln material controlling data (e.g., data 110m of FIG. 1B) from any suitable other subsystems (e.g., a KVMS subsystem (e.g., if one or more kiln models are not maintained by subsystem 104 itself)) and/or (iv) provide and/or control any suitable kiln material controlling module(s) (e.g., raw feed material source selector component(s), etc.) that may be operative to adjust any suitable characteristic(s) of any suitable materials used by kiln apparatus 107 (e.g., quality and/or source of raw feed material, etc.) based on any suitable kiln material controlling data.

An external environment monitoring subsystem 106 may be any suitable subsystem that may be configured to (i) provide and/or control any suitable external environment monitoring module(s) (e.g., sensors, etc.) that may be operative to detect any suitable external environment monitoring data (e.g., data 100e of FIG. 1B) that may be indicative of any suitable characteristic(s) of any suitable environment(s) external to kiln apparatus 107 (e.g., ambient humidity, ambient temperature, current wind speed, etc.) and/or (ii) communicate such external environment monitoring data to any suitable other subsystems (e.g., a KVMS subsystem (e.g., if one or more kiln models are not maintained by subsystem 106 itself)) and/or (iii) receive external environment controlling data (e.g., data 110e of FIG. 1B) from any suitable other subsystems (e.g., a KVMS subsystem (e.g., if one or more kiln models are not maintained by subsystem 106 itself)) (e.g., if any external environmental conditions may be controllable) and/or (iv) provide and/or control any suitable external environment controlling module(s) (e.g., heat/cooling component(s), humidifier component(s) etc.) that may be operative to adjust any suitable characteristic(s) of any suitable environment(s) external to kiln apparatus 107 (e.g., ambient humidity, ambient temperature, current wind speed, etc.) based on any suitable external environment controlling data (e.g., if any external environmental conditions may be controllable (e.g., HVAC of external environment may be controllable)).

A KVMS subsystem 108 may be any suitable subsystem that may be configured to (i) request and/or receive any suitable monitoring data associated with at least one particular kiln apparatus 107 (e.g., kiln apparatus monitoring data from any kiln apparatus monitoring subsystem(s) 102, kiln material monitoring data from any kiln material monitoring subsystem(s) 104, external environment monitoring data from any external environment monitoring subsystem(s) 106, etc.) and/or (ii) access, configure, train, utilize, and/or otherwise manage any suitable kiln model(s) (e.g., neural network(s) and/or learning engine(s), etc.) in conjunction with any received monitoring data associated with at least one particular kiln apparatus 107 for generating any suitable controlling data associated with at least one particular kiln apparatus 107 that may be used to control system 1 in one or more particular ways (e.g., kiln apparatus controlling data for use by any kiln apparatus monitoring subsystem(s) 102, kiln material controlling data for use by any kiln material monitoring subsystem(s) 104, external environment controlling data for use by any external environment monitoring subsystem(s) 106, etc.) and/or (iii) communicate such controlling data to any suitable other subsystems (e.g., one or more of subsystems 102, 104, 106, etc.) for use in controlling system 1 (e.g., for managing variables of kiln apparatus 107 (e.g., for adjusting a user interface presentation to an operator of a kiln apparatus (e.g., to provide a predicted kiln output product state) and/or for adjusting an output of any suitable module(s) of the kiln apparatus(es) or related subsystem(s) for adjusting the operation of the kiln subsystem(s) (e.g., for adjusting the rotation speed, natural gas flow rate, and/or the like of a kiln apparatus for affecting a real density, electrical resistivity, and/or the like of a calcined material output by the kiln apparatus and/or for minimizing the consumption of natural gas/fuel source and/or material loss) and/or for adjusting any suitable property(ies) of the raw feed material and/or for adjusting any suitable characteristics of any suitable external environment)).

One, some, or each subsystem of system 1 may be configured communicate with another one, some, or each subsystem of system 1 via any suitable wired and/or wireless communications network 101. Network 101 may be the internet or any other network, such that when interconnected, a first subsystem may access information (e.g., monitoring data, controlling data, etc.) from a second subsystem as if such information were stored locally at that first subsystem. One, some, or each communications component or communications interface of a first subsystem and/or one, some, or each communications component or communications interface of a second subsystem may be a network interface that may include the mechanical, electrical, and/or signaling circuitry for communicating data over links (e.g., physical links) that may be coupled to network 101.

Although only a single one of each of kiln apparatus 107 and subsystems 102, 104, 106, and 108 are shown in FIG. 1, system 1 may include two or more of one, some, or each of subsystems 102, 104, 106, and 108 and/or kiln apparatus 107, and/or different networks 108 may be provided for enabling communication between different subsystems. Multiple kiln apparatuses 107 may be monitored by a single kiln apparatus monitoring subsystem 102, or each kiln apparatus monitoring subsystem 102 may be utilized for monitoring only a single kiln apparatus 107. Multiple kiln apparatuses 107 may be monitored by a single kiln material monitoring subsystem 104, or each kiln material monitoring subsystem 104 may be utilized for monitoring only a single kiln apparatus 107. Multiple kiln apparatuses 107 may be monitored by a single external environment monitoring subsystem 106, or each external environment monitoring subsystem 106 may be utilized for monitoring the environment of only a single kiln apparatus 107. Multiple kiln apparatuses 107 may be serviced by a single KVMS subsystem 108, or each KVMS subsystem 108 may be utilized for servicing only a single kiln apparatus 107. In some embodiments, one or more subsystems of system 1 may be combined or omitted (e.g., a subsystem 102 and a subsystem 108 may be combined into a single subsystem that may share one or more components and/or modules and/or other characteristics (e.g., location, memory, processing, power, etc.).

As shown in FIG. 1A, a subsystem 10 of system 1 (e.g., one, some, or each of subsystems 102, 104, 106, and 108 of system 1 of FIG. 1) may include a processor component 12, a memory component 13, a communications component 14, a sensor 15, an input/output (“I/O”) component 16, a power supply component 17, a structure or housing 11, and/or a bus 18 that may provide one or more wired or wireless communication links or paths for transferring data and/or power to, from, or between various other components of subsystem 10. In some embodiments, one or more components of subsystem 10 may be combined or omitted. Moreover, subsystem 10 may include other components not combined or included in FIG. 1A and/or several instances of the components shown in FIG. 1A. For the sake of simplicity, only one of each of the components of subsystem 10 is shown in FIG. 1A.

I/O component 16 may include at least one input component (e.g., button, mouse, keyboard, sensor (e.g., sensor 15), lab equipment, etc. (e.g., monitoring module(s) (e.g., kiln apparatus monitoring module(s), kiln material monitoring module(s), external environment monitoring module(s), etc.))) to receive information or other suitable data from a user/apparatus/material/environment and/or at least one output component (e.g., audio speaker, video display, haptic component, actuator, motor, valve, raw feed material source selector component(s), heat/cooling component(s), humidifier component(s), etc. (e.g., controlling module(s) (e.g., kiln apparatus controlling module(s), kiln material controlling module(s), external environment controlling module(s), etc.))) to provide information or other suitable data to a user/apparatus/material/environment, such as a touch screen that may receive input information through a user's touch of a display screen and that may also provide visual information to a user via that same display screen. Memory 13 may include one or more storage mediums, including for example, a hard-drive, flash memory, magnetic storage, permanent memory such as read-only memory (“ROM”), semi-permanent memory such as random access memory (“RAM”), any other suitable type of storage component, or any combination thereof (e.g., for storing data (e.g., data 19d (e.g., a kiln management model 19m))). Memory 13 may include suitable logic, circuitry, and/or code that may enable storage of various types of information, such as received data, generated data, code, and/or configuration information.

Communications component 14 may be provided to allow subsystem 10 to communicate with one or more other subsystems 10 using any suitable communications protocol (e.g., via communications network 101). Communications component 14 can be operative to create or connect to a communications network (e.g., network 101). Communications component 14 can provide wireless communications using any suitable short-range or long-range communications protocol, such as Wi-Fi (e.g., an 802.11 protocol), Bluetooth, radio frequency systems (e.g., 1200 MHz, 2.4 GHz, and 5.6 GHz communication systems), near field communication (“NFC”), Zigbee, wireless local area network (“WLAN”), universal serial bus (“USB”), infrared, protocols used by wireless and cellular telephones and personal e-mail devices, or any other protocol supporting wireless communications. Communications component 14 can also be operative to connect to a wired communications network or directly to another data source wirelessly or via one or more wired connections. Communications component 14 may be a network interface that may include the mechanical, electrical, and/or signaling circuitry for communicating data over physical links that may be coupled to network 101. Such network interface(s) may be configured to transmit and/or receive any suitable data using a variety of different communication protocols, including, but not limited to, TCP/IP, UDP, ATM, synchronous optical networks (“SONET”), any suitable wireless protocols, Frame Relay, Ethernet, Fiber Distributed Data Interface (“FDDI”), and/or the like. In some embodiments, one, some, or each of such network interfaces may be configured to implement one or more virtual network interfaces, such as for Virtual Private Network (“VPN”) access.

Sensor 15 may be any suitable sensor (e.g., monitoring module) that may be configured to sense any suitable data for subsystem 10 (e.g., location-based data via a GPS sensor system, image data, inertia or inertial data, motion data, environmental data, biometric data, kiln apparatus monitoring data, kiln material monitoring data, external environment monitoring data, etc.). Sensor 15 may be a sensor assembly that may include any suitable sensor or any suitable combination of sensors operative to detect any suitable characteristic(s) of subsystem 10 and/or of a user thereof and/or of an associated apparatus (e.g., kiln apparatus 107) and/or its environment/surroundings. Sensor 15 may include any suitable sensor(s), including, but not limited to, one or more of a GPS sensor, wireless communication sensor, image sensor, inertial sensor (e.g., inertial measurement unit (“IMU”)), accelerometer, directional sensor (e.g., compass), gyroscope, motion sensor, pedometer, passive infrared sensor, ultrasonic sensor, microwave sensor, a tomographic motion detector, camera, biometric sensor, light sensor, timer, and/or the like. Sensor 15 may include one or more image sensors for capturing video image data and/or still image data (e.g., sensor 15 may include a rear-facing camera and/or a front-facing camera and/or any other directional camera (e.g., on a gimballed and/or gyrostabilized platform and/or the like) and/or the like). Sensor 15 may include any suitable sensor components or subassemblies for detecting any suitable movement of subsystem 10 and/or of a user thereof and/or of an associated apparatus (e.g., kiln apparatus 107). For example, sensor 15 may include one or more three-axis acceleration motion sensors (e.g., an accelerometer) that may be operative to detect linear acceleration in three directions (i.e., the x- or left/right direction, the y- or up/down direction, and the z- or forward/backward direction). As another example, sensor 15 may include one or more single-axis or two-axis acceleration motion sensors that may be operative to detect linear acceleration only along each of the x- or left/right direction and the y- or up/down direction, or along any other pair of directions. In some embodiments, sensor 15 may include an electrostatic capacitance (e.g., capacitance-coupling) accelerometer that may be based on silicon micro-machined micro electro-mechanical systems (“MEMS”) technology, including a heat-based MEMS type accelerometer, a piezoelectric type accelerometer, a piezo-resistance type accelerometer, and/or any other suitable accelerometer (e.g., which may provide a pedometer or other suitable function). Sensor 15 may be operative to directly or indirectly detect rotation, rotational movement, angular displacement, tilt, position, orientation, motion along a non-linear (e.g., arcuate) path, or any other non-linear motions. Additionally or alternatively, sensor 15 may include one or more angular rate, inertial, and/or gyro-motion sensors or gyroscopes for detecting rotational movement. For example, sensor 15 may include one or more rotating or vibrating elements, optical gyroscopes, vibrating gyroscopes, gas rate gyroscopes, ring gyroscopes, magnetometers (e.g., scalar or vector magnetometers), compasses, attitude sensors (e.g., for roll, pitch, yaw, etc.) and/or the like. Any other suitable sensors may also or alternatively be provided by sensor 15 for detecting motion or otherwise at or with subsystem 10, such as any suitable pressure sensors, altimeters, flow sensors, spin sensors, temperature sensors, thermocouples, odor sensors, gas sensors, fluid sensors, humidity sensors, opacity sensors, actuator position sensors, belt rate sensors, electrical resistivity sensors, real density sensors, and/or the like. Using sensor 15, subsystem 10 may be configured to determine a velocity, acceleration, orientation, and/or any other suitable motion attribute of subsystem 10 or an associated apparatus (e.g., kiln apparatus 107). Sensor 15 may include any suitable sensor components or subassemblies for detecting any suitable biometric data and/or health data and/or the like of a user of user subsystem 10. For example, sensor 15 may include any suitable biometric sensor that may include, but is not limited to, one or more facial recognition sensors, fingerprint scanners, iris scanners, retinal scanners, voice recognition sensors, gait sensors, hair sensors, hand geometry sensors, signature scanners, keystroke dynamics sensors, vein matching sensors, heart beat sensors, body temperature sensors, odor or scent sensors, behavioral biometric sensors (e.g., behavioral modeling of movement, orientation, gesture, pausality, etc.), DNA sensors, sensors for any unclonable or extremely difficult to replicate personal function, and/or any other suitable sensors for detecting any suitable metrics related to any suitable characteristics of a user, which may also include health-related optical sensors, capacitive sensors, thermal sensors, electric field (“eField”) sensors, and/or ultrasound sensors, such as photoplethysmogram (“PPG”) sensors, electrocardiography (“ECG”) sensors, galvanic skin response (“GSR”) sensors, posture sensors, stress sensors, photoplethysmogram sensors, and/or the like. Sensor 15 may include a microphone, camera, scanner (e.g., a barcode scanner or any other suitable scanner that may obtain product identifying information from a code, such as a linear barcode, a matrix barcode (e.g., a quick response (“QR”) code), or the like), proximity sensor, light detector, temperature sensor, motion sensor, biometric sensor (e.g., a fingerprint reader or other feature (e.g., facial) recognition sensor, which may operate in conjunction with a feature-processing application that may be accessible to subsystem 10 for attempting to authenticate a user), line-in connector for data and/or power, and/or combinations thereof. In some examples, each sensor can be a separate device, while, in other examples, any combination of two or more of the sensors can be included within a single device. For example, a gyroscope, accelerometer, photoplethysmogram, galvanic skin response sensor, and temperature sensor can be included within a wearable subsystem 10, such as a smart watch, while a scale, blood pressure cuff, blood glucose monitor, SpO2 sensor, respiration sensor, posture sensor, stress sensor, and asthma inhaler can each be separate devices. Motion sensor(s) may be used to facilitate movement and orientation related functions of subsystem 10 and/or associated apparatus, for example, to detect movement, direction, and/or orientation of subsystem 10. While specific examples are provided, it should be appreciated that other sensors can be used and other combinations of sensors can be combined into a single subsystem 10. Sensor 15 may include any suitable sensor components or subassemblies for detecting any suitable characteristics of any suitable condition of the lighting of the environment of subsystem 10 or an associated apparatus or material. For example, sensor 15 may include any suitable light sensor that may include, but is not limited to, one or more ambient visible light color sensors, illuminance ambient light level sensors, ultraviolet (“UV”) index and/or UV radiation ambient light sensors, and/or the like. Any suitable light sensor or combination of light sensors may be provided for determining the illuminance or light level of ambient light in the environment of subsystem 10 (e.g., in lux or lumens per square meter, etc.) and/or for determining the ambient color or white point chromaticity of ambient light in the environment of subsystem 10 (e.g., in hue and colorfulness or in x/y parameters with respect to an x-y chromaticity space, etc.) and/or for determining the UV index or UV radiation in the environment of subsystem 10 (e.g., in UV index units, etc.). A suitable light sensor may include, for example, a photodiode, a phototransistor, an integrated photodiode and amplifier, or any other suitable photo-sensitive device. In some embodiments, more than one light sensor may be integrated into subsystem 10. Sensor 15 may include any suitable sensor components or subassemblies for detecting any suitable characteristics of any suitable condition of the air quality of the environment of subsystem 10 or of an associated apparatus and/or material. For example, sensor 15 may include any suitable air quality sensor that may include, but is not limited to, one or more ambient air flow or air velocity meters, ambient oxygen level sensors, volatile organic compound (“VOC”) sensors, ambient humidity sensors, ambient temperature sensors, and/or the like. Any suitable ambient air sensor or combination of ambient air sensors may be provided for determining the oxygen level of the ambient air in the environment of subsystem 10 (e.g., in O₂% per liter, etc.) and/or for determining the air velocity of the ambient air in the environment of subsystem 10 (e.g., in kilograms per second, etc.) and/or for determining the level of any suitable harmful gas or potentially harmful substance (e.g., VOC (e.g., any suitable harmful gasses, scents, odors, etc.) or particulate or dust or pollen or mold or the like) of the ambient air in the environment of subsystem 10 (e.g., in HG % per liter, etc.) and/or for determining the humidity of the ambient air in the environment of subsystem 10 (e.g., in grams of water per cubic meter, etc. (e.g., using a hygrometer)) and/or for determining the temperature of the ambient air in the environment of subsystem 10 (e.g., in degrees Celsius, etc. (e.g., using a thermometer)). Sensor 15 may include any suitable sensor components or subassemblies for detecting any suitable characteristics of any suitable condition of the sound quality of the environment of subsystem 10 and/or associated apparatus and/or material. For example, sensor 15 may include any suitable sound quality sensor that may include, but is not limited to, one or more microphones or the like that may determine the level of sound pollution or noise in the environment of subsystem 10 (e.g., in decibels, etc.). Sensor 15 may also include any other suitable sensor for determining any other suitable characteristics about a user of subsystem 10 and/or the environment of subsystem 10 and/or apparatus and/or material associated with subsystem 10. In some examples, different sensors can be placed in different locations inside or on the surfaces of subsystem 10 (e.g., some located inside housing 11 and some attached to an attachment mechanism (e.g., a wrist band coupled to a housing of a wearable device), or the like). In other examples, one or more sensors can be worn by a user separately as different parts of a single subsystem 10 or as different devices (e.g., for associating with different respective components of an associated apparatus (e.g., kiln apparatus 107)). In such cases, the sensors can be configured to communicate with subsystem 10 using a wired and/or wireless technology (e.g., via communications component 14). In some examples, sensors can be configured to communicate with each other and/or share data collected from one or more sensors.

Power supply 17 can include any suitable circuitry for receiving and/or generating power, and for providing such power to one or more of the other components of subsystem 10. For example, power supply assembly 17 can be coupled to a power grid (e.g., when subsystem 10 is not acting as a portable device or when a battery of the subsystem is being charged at an electrical outlet with power generated by an electrical power plant). As another example, power supply assembly 17 may be configured to generate power from a natural source (e.g., solar power using solar cells). As another example, power supply assembly 17 can include one or more batteries for providing power (e.g., when subsystem 10 is acting as a portable device). Subsystem 10 may also be provided with a housing 11 that may at least partially enclose one or more of the components of subsystem 10 for protection from debris and other degrading forces external to subsystem 10. Each component of subsystem 10 may be included in the same housing 11 (e.g., as a single unitary device, such as a portable media device or server) and/or different components may be provided in different housings (e.g., a keyboard input component may be provided in a first housing that may be communicatively coupled to a processor component and a display output component that may be provided in a second housing, such as in a desktop computer set-up). In some embodiments, subsystem 10 may include other components not combined or included in those shown or several instances of the components shown.

Processor 12 may be used to run one or more applications, such as an application 19 that may be accessible from memory 13 (e.g., as a portion of data 19d) and/or any other suitable source (e.g., from network 101 or any other subsystem and an active internet or other suitable data connection). Application 19 may include, but is not limited to, one or more operating system applications, firmware applications, communication applications (e.g., for enabling communication of data between subsystems 10), third party service applications (e.g., sensor applications, social media applications, etc.), internet browsing applications (e.g., for interacting with a website provided by a third party subsystem or other subsystem for enabling subsystem 10 to interact with an online service), application programming interfaces (“APIs”), software development kits (“SDKs”), APS applications (e.g., a web application or a native application that may be at least partially produced by KVMS subsystem 108 or otherwise for enabling subsystem 10 to interact with an online service), or any other suitable applications (e.g., a KVMS application). For example, processor 12 may load an application 19 as an interface program to determine how instructions or data received via an input component of I/O component 16 or other component of subsystem 10 (e.g., sensor 15 and/or communications component 14) may manipulate the way in which information may be stored (e.g., in memory 13) and/or provided to the user or associated apparatus via an output component of I/O component 16 and/or to another subsystem via communications component 14. As one example, application 19 may provide a user or subsystem 10 with the ability to interact with a KVMS platform (“KVMSP”) of system 1, where application 19 may be a third party application that may be running on subsystem 10 (e.g., an application associated with KVMS subsystem 108 and/or a third party subsystem or the like) that may be loaded on subsystem 10 (e.g., using communications component 14) via an application market, such as the Apple App Store or Google Play, or that may be accessed via an internet application or web browser (e.g., by Apple Safari or Google Chrome) that may be running on subsystem 10 and that may be pointed to a uniform resource locator (“URL”) whose target or web resource may be managed by or otherwise affiliated with the KVMSP. Processor 12 may include suitable logic, circuitry, and/or code that may enable processing data and/or controlling operations of subsystem 10. In this regard, processor 12 may be enabled to provide control signals to various other components of subsystem 10. Processor 12 may also control transfers of data between various portions of subsystem 10 Processor 12 may further implement an operating system or may otherwise execute code to manage operations of subsystem 10.

Subsystem 10 may be configured to have any physical structure (e.g., by one or more housings 11) that may include, but is not limited to, any suitable portable, mobile, wearable, implantable, rideable, controllable, or hand-held mobile electronic device (e.g., a portable and/or handheld media player), a headset, a helmet, glasses, a wearable, a tablet computer, a laptop computer, a controller, a VR and/or AR and/or MR device, a vehicle, server, sensor system, actuator system, and/or any other machine or device or housing or structure that can be utilized to manage variables of an apparatus (e.g., kiln apparatus 107). Alternatively, subsystem 10 may not be portable during use, but may instead be generally stationary (e.g., as a type of KVMS subsystem 108). Not all of the depicted components may be used in all implementations, however, and one or more implementations may include additional or different components than those shown in FIG. 1A. In one or more implementations, one or more of processor 12, memory 13, sensor(s) 15, communications interface or communications component 14, I/O component 16, and/or power supply 17, and/or one or more portions thereof, may be implemented in software (e.g., subroutines and code), may be implemented in hardware (e.g., an application specific integrated circuit (“ASIC”), a field programmable gate array (“FPGA”), a programmable logic device (“PLD”), a controller, a state machine, gated logic, discrete hardware components, or any other suitable devices), and/or a combination of both. Variations in the arrangement and type of the components may be made without departing from the spirit or scope of the claims as set forth herein. Additional components, different components, or fewer components may be provided.

FIG. 1B shows one particular implementation of system 1 that may include kiln apparatus 107, kiln apparatus monitoring subsystem 102, kiln material monitoring subsystem 104, external environment monitoring subsystem 106, and KVMS subsystem 108. As shown in FIG. 1B, kiln apparatus monitoring subsystem 102 may include any suitable kiln apparatus processor controller subsystem 111 for providing/supporting any suitable kiln apparatus monitoring module(s) for detecting any suitable kiln apparatus monitoring data 100a from kiln apparatus 107 and/or for providing/supporting any suitable kiln apparatus controlling module(s) for controlling kiln apparatus 107 based on any suitable kiln apparatus controlling data 110a (e.g., analog and discrete, inputs and outputs). In some embodiments, subsystem 111 may include any suitable hardware, such as a ControlLogix controller system by Rockwell Automation of Milwaukee, Wisconsin (e.g., ControlLogix 5580 controllers, ControlLogix 5570 controllers, etc.) and/or any suitable software, such as Studio 5000 design software by Rockwell Automation. As also shown, kiln apparatus monitoring subsystem 102 may also include any suitable server, such as a kiln apparatus monitoring gateway subsystem 112, which may be configured to provide a gateway for all kiln apparatus data (e.g., kiln apparatus monitoring data 100a and/or kiln apparatus controlling data 10a). In some embodiments, subsystem 112 may include any suitable hardware, such as an open platform communication foundation's unified architecture (“OPC UA”) server (e.g., for converting data from Rockwell processor data to OPC UA data and/or vice versa (e.g., a cross-platform, open-source, IEC62541 standard for data exchange from sensors to cloud applications)), and/or any suitable software, such as FactoryTalk Edge Gateway software and/or FactoryTalk Linx (“FTLinx”) gateway software by Rockwell Automation. For example, OPC UA may be configured to utilize a machine-to-machine communication protocol for industrial automation and developed by the OPC Foundation. The OPC UA platform in a platform-independent service-oriented architecture may integrate individual OPC Classic specifications into an extensible framework. OPC UA may simplify industrial connectivity so all devices, automation systems, and software applications can be integrated using a secure and platform-independent standard. Using OPC UA may allow remote devices to be connected easily (e.g., by Cumulocity Internet of Things (“IoT”) either in the cloud or at the edge, thereby enabling device diagnostics, asset management, monitoring, reporting, and/or any other suitable applications. Subsystem 112 may be configured to provide any suitable human machine interface(s) (“HMI(s)”) (e.g., screens, views, and/or any other suitable presentations that any suitable system operator(s) 109 may use to monitor and/or control kiln apparatus 107 (e.g., FactoryTalk/FactoryTalk View by Rockwell Automation may be used to create the HMIs/controls for kiln apparatus 107)). Subsystem 112 may be provided and/or controller and/or managed by any suitable operations technology (“OT”) team (e.g., entity(ies) that may be responsible for an automation network including processors, controls software (e.g., Rockwell Automation, Schneider Electric of Rueil-Malmaison, France, etc.), automation logic (e.g., PIDs, interlocks, etc.), HNIIs (interfaces with end users/operators), historian tags/storage, backups of automation programs, and/or the like.

As shown in FIG. 1B, kiln material monitoring subsystem 104 may include any suitable kiln material sampling subsystem 118 for providing/supporting any suitable kiln material monitoring module(s) for detecting any suitable kiln material monitoring data 100m from kiln apparatus 107 and/or for providing/supporting any suitable kiln material controlling module(s) for controlling material (e.g., raw feed material) of kiln apparatus 107 based on any suitable kiln material controlling data 110m. In some embodiments, subsystem 118 may include any suitable hardware and/or any suitable software (e.g., belt weight scales, moisture analyzers, XRF equipment, balances, ovens, etc.) that may be operative to collect and analyze any suitable physical product from kiln apparatus 107 (e.g., raw feed material, conditioned material, calcined material, etc.) (e.g., using any suitable laboratory equipment), where sample qualities may be deemed to represent a set of product. As also shown, kiln material monitoring subsystem 104 may also include any suitable advanced manufacturing production and planning software (“AMPPS”) subsystem 119 that may be configured to capture, share, and/or present any suitable types of operational data. For example, in some embodiments, on the raw side, one, some, any, or all planned blend percentages may be defined in AMPPS and then a production supervisor may be operative to provide real time updates to the actual blend being charged (e.g., every three hours). There may be little to no equipment for this, where a raw silo charging operator may be operative to follow an instruction from AMPPS and a supervisor may confirm that the plan was followed and updates, when needed, if unable to follow the plan. This may be used to calculate real time qualities that may be fed into the kiln, including, but not limited to, volatile matter, vanadium, moisture, and/or the like. Additionally or alternatively, moisture analysis may be performed on a raw sample. The raw data may be collected in AMPPS (e.g., using a scale), which may perform any suitable mathematical calculation(s) to determine moisture content percentage. Samples of conditioned material may be collected periodically and analyzed to determine real density (e.g., on a specialized piece of equipment, such as a pycnometer). This information may be collected by AMPPS and fed to the network and the system may be configured to respond to this information accordingly. Many qualities may be analyzed coming out of the kiln, as may be due to certain customers having many specifications. Some qualities may be controlled in the kiln, including, but not limited to, volatile matter (“VM”) (e.g., VM may be at least partially eliminated by maintaining a minimum temperature), real density, electrical resistivity, and/or the like. In some embodiments, all results may be monitored and measures may be taken to change the raw feed blend to affect the other qualities and AMPPS may be configured to handle the collection and presentation of the data to facilitate in the monitoring.

As also shown in FIG. 1B, a portion of system 1 including subsystem 111 and subsystem 118 and kiln apparatus 107 may be referred to herein as kiln variable monitoring apparatus 103, and/or another portion of system 1 including subsystem 112 and subsystem 119 and operator(s) 109 may be referred to herein as kiln operator apparatus 105. In some embodiments, system 1 may be configured to provide any suitable operator(s) 109 with two or more distinct presentations of system data, such as a first presentation provided by kiln apparatus monitoring gateway subsystem 112 (e.g., for data 100a and/or date 10a) and a second presentation provided by AMPPS subsystem 119 (e.g., for data 100m and/or date 110m). For example, there may be two presentations (e.g., two displays) when AMPPS may be a web-based application that may be accessible from anywhere you can get internet access. This may be helpful for communicating and managing information throughout an organization. The kiln apparatus, however, may be kept shielded from the outside world to prevent a hostile takeover of an organization's physical assets and may, therefore, not provide web-based access from the outside. Therefore, for example, the two presentations may be on two different networks, with intent. In some embodiments, kiln apparatus monitoring gateway subsystem 112 may be configured to determine how the kiln(s) are doing, while AMPPS subsystem 119 may be configured to determine how the material is doing.

As shown in FIG. 1B, system 1 may include external environment monitoring subsystem 106 associated with any suitable environment 115 of kiln apparatus 107 and may be configured to (i) provide and/or control any suitable external environment monitoring module(s) (e.g., sensors, etc.) that may be operative to detect any suitable external environment monitoring data 100e that may be indicative of any suitable characteristic(s) of environment 115 (e.g., ambient humidity, ambient temperature, current wind speed, etc.) and/or (ii) communicate such external environment monitoring data 100e to any suitable other subsystems (e.g., KVMS subsystem 108) and/or (iii) receive external environment controlling data 110e from any suitable other subsystems (e.g., KVMS subsystem 108) and/or (iv) provide and/or control any suitable external environment controlling module(s) (e.g., heat/cooling component(s), humidifier component(s) etc.) that may be operative to adjust any suitable characteristic(s) of environment 115 (e.g., ambient humidity, ambient temperature, etc.) based on any suitable external environment controlling data 110e. Such external environment monitoring data 100e may be any suitable data that may be indicative of any suitable condition(s) of environment 115 as may be detected by subsystem 106 (e.g., as may be detected by any suitable input assembly and/or any suitable sensor assembly of subsystem 106). For example, subsystem 106 may include any suitable sensor assembly with any suitable sensors that may be operative to determine any suitable characteristic of environment 115, which may be positioned in an environment shared by kiln apparatus 107. As just one example, subsystem 106 may include or may be in communication with a heating, ventilation, and air conditioning (“HVAC”) subsystem of environment 115, and subsystem 106 may be able to access any suitable HVAC data (e.g., any suitable external environment monitoring data 100e) from environment 115 indicative of any suitable HVAC characteristics (e.g., temperature, humidity, air velocity, oxygen level, harmful gas level, etc.) of environment 115, such as when kiln apparatus 107 is located within that environment 115. As just one other example, subsystem 106 may include or may be in communication with a lighting subsystem of environment 115, and subsystem 106 may be able to access any suitable lighting data (e.g., any suitable external environment monitoring data 100e) from environment 115 indicative of any suitable lighting characteristics (e.g., brightness, color, etc.) of environment 115, such as when kiln apparatus 107 is located within that environment 115. As yet just one other example, subsystem 106 may include or may be in communication with a sound subsystem of environment 115, and subsystem 106 may be able to access any suitable sound data (e.g., any suitable external environment monitoring data 100e) from environment 115 indicative of any suitable sound characteristics (e.g., volume, frequency characteristics, etc.) of environment 115, such as when kiln apparatus 107 is located within that environment 115. As yet just one other example, subsystem 106 may be provided by a weather service (e.g., a subsystem operated by a local weather service or a national or international weather service (e.g., a public weather data provider or an in-house local weather station)) that may be operative to determine the weather (e.g., temperature, humidity, gas levels, air velocity, etc.) of environment 115, such as when kiln apparatus 107 is located within that environment 115. It is to be understood that subsystem 106 may be any suitable subsystem that may be operative to determine or generate and/or control and/or access any suitable external environment monitoring data 100e about a particular environment 115 and share such data (e.g., as any suitable external environment monitoring data 100e) with KVMS subsystem 108 at any suitable time, such as to augment and/or enhance the KVMS of system 1. KVMS subsystem 108 may be operative to communicate any suitable external environment controlling data 110e to external environment monitoring subsystem 106 that may be used to control any suitable external environment controlling module(s) (e.g., actuators, motors, valves, etc. of any suitable HVAC subsystem, lighting subsystem, sound subsystem, weather service subsystem, etc.) that may be operative to adjust any suitable characteristic(s) of environment 115 (e.g., temperature, humidity, light, sound, etc.) based on any suitable external environment controlling data 110e. Any suitable maximum threshold distance between the kiln and the ambient atmosphere being monitored may be used for associating the two. Some models indicate that there is a relationship between ambient temperature and real density, and an inverse relationship with ambient humidity and real density, while a relationship between wind speed and real density may also be determined. In some embodiments, one or some or all monitored characteristics of an ambient environment cannot be controlled (e.g., when a kiln is located outside and the outside environment is difficult to control), but, instead, a model may consider current ambient conditions to adjust kiln settings to achieve certain performance (e.g., to hit a real density target while minimizing fuel use, etc.).

As shown in FIG. 1B, system 1 may include KVMS subsystem 108 associated with kiln apparatus 107 and environment 115. As shown, KVMS subsystem 108 may include any suitable server, such as a material and environment monitoring gateway subsystem 116, which may be configured to provide a gateway for all kiln material data (e.g., kiln material monitoring data 100m and/or kiln material controlling data 110m) and/or for all external environment data (e.g., external environment monitoring data 100e and/or external environment controlling data 110e). In some embodiments, subsystem 116 may include any suitable hardware, such as an OPC UA server (e.g., for converting data from subsystem 104 and/or subsystem 106 to OPC UA data and/or vice versa), and/or any suitable software, such as Softing DataFEED (e.g., third party software that may enable the conversion and/or storage of various types of data that can then be shared amongst applications). Subsystem 116 may be a data repository and/or may be configured to be used to read from a database (e.g., a structured query language “SQL” database) and/or to write to a server (e.g., an OPC UA server), which may bridge communication.

As shown in FIG. 1B, KVMS subsystem 108 may include any suitable server, such as a monitoring mapping subsystem 113, which may be configured to provide data mapping from subsystem 112 and/or subsystem 116 to visible tags for a kiln model server 114 using any suitable software, such as Cogent DataHub software by Cogent Real-Time Systems Inc. of Ontario, Canada. In some embodiments, subsystem 113 may include any suitable hardware, such as an OPC UA client, which may act as a DataHub gateway.

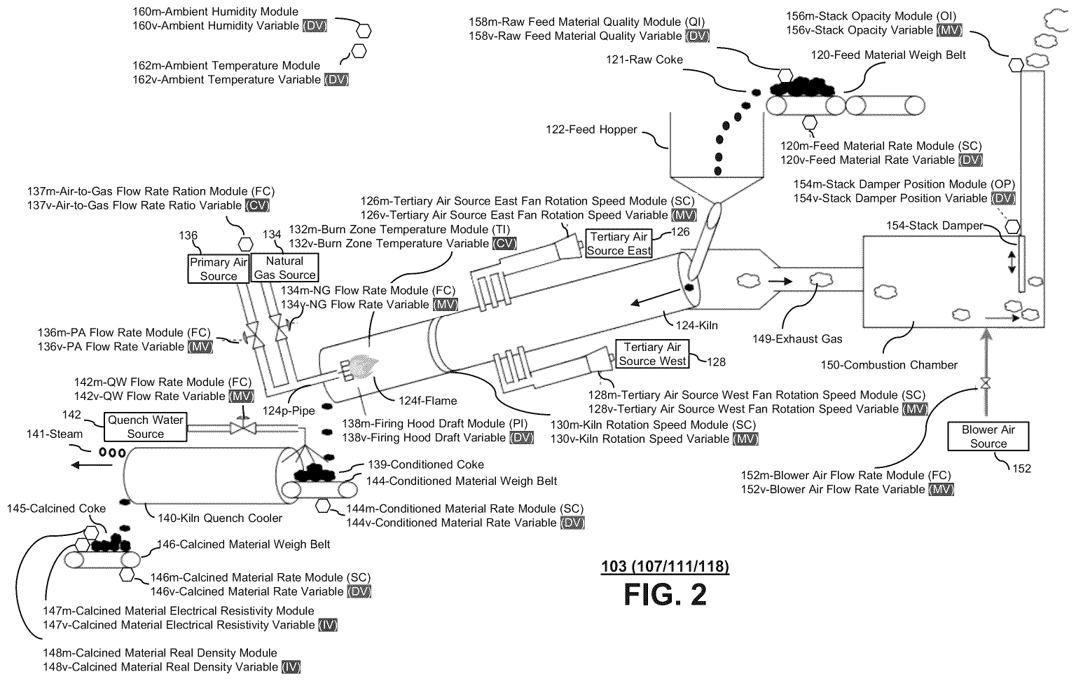

As shown in FIG. 1B, KVMS subsystem 108 may include any suitable server, such as a kiln model server 114, which may be configured to provide any suitable custodian for any suitable kiln management model 19m that may receive any suitable monitoring data 100 (e.g., kiln apparatus monitoring data 100a via subsystems 111, 112, and 113 and/or kiln material monitoring data 100m via subsystems 118, 119, 116, and 113 and/or external environment monitoring data 100e via subsystems 106, 116, and 113) and/or provide any suitable controlling data 110 (e.g., kiln apparatus controlling data 10a to subsystem 111 via subsystems 113 and 112, kiln material controlling data 110m to subsystem 118 via subsystems 113, 116, and 119, and/or external environment controlling data 110e to subsystem 106 via subsystems 113 and 116). In some embodiments, subsystem 114 may be any suitable server (e.g., an Imubit Linux server (e.g., a deep learning process control platform) by Imubit Inc. of Houston, Texas (e.g., an Imubit closed loop neural network platform)) that may perform any suitable setpoint calculations. In some embodiments, subsystem 114 may provide any suitable artificial intelligence (“AI”) process optimization technology that may enable plant managers (e.g., managers of kiln apparatus 107) to discover, engineer, and/or monetize process optimization opportunities. Subsystem 114 may include a proportional-integral-derivative controller (“PID” controller or three-term controller) that may be configured as a control loop mechanism employing feedback and/or any suitable application(s) requiring continuously modulated control. A PID controller may continuously calculate an error value e(t) as the difference between a desired setpoint (“SP”) and a measured process variable (“PV”) and apply a correction based on proportional, integral, and derivative terms (e.g., denoted P, I, and D respectively), whereby PIC may be configured to apply an accurate and responsive correction to a control function automatically. In some embodiments, subsystem 114 may include an inferential neural net (e.g., a layer of software that may be configured to model any suitable inferential variable(s) of the system (e.g., an electrical resistivity variable of a calcined material provided by kiln apparatus 107 (e.g., variable 147v of FIG. 2), a real density variable of a calcined material provided by kiln apparatus 107 (e.g., variable 148v of FIG. 2), etc.)). In some embodiments, subsystem 114 may include a deep learning predictor (“DLP”) (e.g., a layer of software that may be configured to perform any suitable prediction calculations for any inferential variable(s) (e.g., it may be configured to combine historical behavior with current conditions to predict any inferential value(s))). In some embodiments, subsystem 114 may include a deep learning controller (“DLC”) (e.g., a layer of software that may be configured to use any suitable predictions to control kiln apparatus 107 in any suitable ways (e.g., to define any suitable component(s) of controlling data 110) in order to achieve any desired outcome(s)). Therefore, in some embodiments, subsystem 114 may be configured to enable deep learning process control (“DLPC”) (e.g., an entire process from inferential to DLP to DLC).

As shown in FIG. 1B, KVMS subsystem 108 may include any suitable server (e.g., local physical server, virtual server, etc.), such as a monitoring cloud server 117, which may be configured to provide any suitable storage for subsystem 114 (e.g., Imubit cloud monitoring). For example, any suitable data from subsystem 114 may be communicated from subsystem 114 to subsystem 117 as an encrypted data set (e.g., via simple mail transfer protocol (“SMTP”), etc.).

As shown in FIG. 1B, a communication path may be provided back from KVMS subsystem 108 to kiln material monitoring subsystem 104, where any suitable kiln material controlling data 110m may be communicated from the controlling kiln model back to some potential kiln material controlling module(s) (e.g., raw feed material source selector component(s), etc.) that may be operative to adjust any suitable characteristic(s) of any suitable materials used by kiln apparatus 107 (e.g., quality and/or source of raw feed material, etc.). Therefore, at least raw feed material qualities may be adjusted (e.g., automatically or otherwise) based on control instructions from the kiln model.

As shown in FIG. 1B, a communication path may be provided back from KVMS subsystem 108 to external environment monitoring subsystem 106, where any suitable external environment controlling data 110e may be communicated from the controlling kiln model back to some potential external environment controlling module(s) (e.g., heat/cooling component(s), humidifier component(s), fans, etc.) that may be operative to adjust any suitable characteristic(s) of any suitable environment 115 external to kiln apparatus 107 (e.g., ambient humidity, ambient temperature, wind speed, etc.), which may be useful if/when one or some characteristics of an environment external to the kiln apparatus may be controlled. For example, ambient temperature or ambient humidity or ambient wind may be adjusted (e.g., automatically or otherwise) based on control instructions from the kiln model when possible to be controlled in one or more ways. Otherwise, in some embodiments, while reactions to monitored external environmental characteristics may be possible, the characteristics themselves may not be controlled.

FIG. 2 shows one particular implementation of kiln variable monitoring apparatus 103 (e.g., an exemplary portion of system 1 that may include kiln apparatus 107 and/or at least a portion of subsystem 111 and/or at least a portion of subsystem 118). As shown, kiln apparatus 107 may include a feed material weigh belt 120, a feed hopper 122, a kiln 124, a conditioned material weigh belt 144, a kiln quench cooler 140, a calcined material weigh belt 146, a combustion chamber 150, and/or a stack damper 154. Feed material weigh belt 120 may be configured to receive and support and eventually move any suitable feed material 121, such as raw coke 121, into feed hopper 121, which may pass feed material 121 through a material input opening of kiln 124 and into kiln 124, where that opening or otherwise of kiln 124 may pass exhaust gas 149 from within kiln 124 to combustion chamber 150, which may provide stack damper 154 whose position may be adjusted for selectively releasing exhaust gas 149 from combustion chamber 150. A material output opening of kiln 124 may pass conditioned material, such as conditioned coke 139 (e.g., a transitioned form of raw coke 121 based on the effect(s) of kiln 124), on to conditioned material weigh belt 144, where belt 144 may be configured to receive and support and eventually move conditioned coke 139 into a material input opening of kiln quench cooler 140. A material output opening of kiln quench cooler 140 may pass steam 141 into an external environment and/or may pass calcined material, such as calcined coke 145 (e.g., a transitioned form of conditioned coke 139 based on the effect(s) of kiln quench cooler 140), on to calcined material weigh belt 146, where belt 146 may be configured to receive and support and/or eventually move conditioned coke 145 (e.g., into any suitable laboratory equipment (e.g., for further processing and/or analysis and/or the like). In some embodiments, kiln 124 may be a cylindrical vessel, which may be inclined slightly (e.g., from the horizontal, as shown), and which may be rotated slowly about its longitudinal axis. As kiln 124 rotates, feed material 121 may gradually move down from the material input opening of kiln 124 at its upper end towards the material output opening of kiln 124 at its lower end, and the material may undergo a certain amount of stirring and mixing. Hot gases may pass along kiln 124, sometimes in the same direction as the process material (i.e., co-current), but often in the opposite direction (i.e., counter-current). The hot gases may be generated in an external furnace or may be generated by a flame 124f inside kiln 124. Such a flame may be projected from a burner-pipe 1²⁴p. In some embodiments, fuel for this may be any suitable fuel source, such as gas (e.g., natural gas), oil, pulverized petroleum coke, or pulverized coal.

Kiln variable monitoring apparatus 103 (e.g., kiln apparatus 107 and/or kiln apparatus processor controller subsystem 111 and/or kiln material sampling subsystem 118) may include any suitable number and/or type(s) of modules (e.g., monitoring and/or controlling (“MC”) modules) that may be operative to detect any suitable type(s) of monitoring data (e.g., data 100a, 100m, 100e, etc.) that may be indicative of any suitable characteristic(s) of system 1 (e.g., of the kiln apparatus, the kiln materials, and/or the external environment) and/or to adjust any suitable characteristic(s) of system 1 (e.g., of the kiln apparatus, the kiln materials, and/or the external environment) based on any suitable type(s) of controlling data (e.g., data 110a, 110m, 110e, etc.).

For example, apparatus 103 (e.g., subsystem 118) may include a raw feed material quality MC module 158m that may be configured to (i) detect any suitable raw feed material quality variable(s) 158v from raw feed material 121 (e.g., the Vanadium percentage of the raw feed material (e.g., a weighted average raw feed x-ray fluorescence (“XRF”) for trace metals)) for generating one or more raw feed material quality variable components of kiln material monitoring data 100m (e.g., MC module 158m may include any suitable monitoring module(s) or quality indicator(s) (“QIs”), such as laboratory equipment, sensor(s), or other information source(s) that may be operative to detect any suitable variable(s) 158v from feed material 121) and/or (ii) adjust any suitable raw feed material quality variable(s) 158v of raw feed material 121 based on any suitable kiln material controlling data 110m (e.g., MC module 158m may include any suitable controlling module(s), such as raw feed material source selector component(s) and/or QI controller(s) (e.g., a PID loop may be set up to control the quality of raw feed material 121) that may be operative to adjust variable(s) 158v of feed material 121). In some embodiments, the quality of the raw feed material may not be controlled with the belts. Instead, the quality of the raw feed material may be controlled through instructions via AMPPS that may be provided to a loader operator. However, in some embodiments, the feed quality may be controlled through PID loops and controllers (e.g., a series of raw feeds silos may be provided, each with a different specific material in it, and the amount of each product added to the kiln therefrom may be controlled). Alternatively, product may be stored in static stockpiles and a front loader operator may be operative to collect the appropriate material based on data coming from AMPPS, and that operator may dump the material into a blend silo, which may eventually feed the kilns. Moisture may be considered (e.g., as may be calculated by weighing the wet material on a mass balance, cooking off the moisture in an oven at a specified temperature for a specified period, then re-weighing the material and determining how much material was lost, which would be equal to the moisture). Additionally or alternatively, volatile matter (“VM”), may be considered (e.g., as may be calculated by weighing the dry material, cooking off the VM in an oven at a specified temperature for a specified period (e.g., this may be a higher temperature than the moisture test and a longer period of time in the oven), then re-weighing the material and determining how much material was lost, which would be equal to the VM).

Additionally or alternatively, apparatus 103 (e.g., subsystem 111) may include a feed material rate MC module 120m that may be configured to (i) detect any suitable feed material rate variable(s) 120v of feed material weigh belt 120 (e.g., the rate of feed material 121 that may be introduced by belt 120 to hopper 122/kiln 124 (e.g., amount per time (e.g., 20-28 tons per hour))) for generating one or more feed material rate variable components of kiln apparatus monitoring data 100a (e.g., MC module 120m may include any suitable monitoring module(s) or belt speed sensors or weight scales or other information source(s) that may be operative to detect any suitable variable(s) 120v from feed material weigh belt 120) and/or (ii) adjust any suitable feed material rate variable(s) 120v of belt 120 based on any suitable kiln apparatus controlling data 110a (e.g., MC module 120m may include any suitable controlling module(s), such as one or more speed controllers for belt 120 (e.g., a speed control (“SC”), where a PID loop may be set up to control the speed of belt 120) that may be operative to adjust variable(s) 120v of belt 120).

Additionally or alternatively, apparatus 103 (e.g., subsystem 111) may include a kiln rotation speed MC module 130m that may be configured to (i) detect any kiln rotation speed variable(s) 130v of kiln 124 (e.g., the rotational speed of a cylindrical vessel of kiln 124) for generating one or more kiln rotation speed variable components of kiln apparatus monitoring data 100a (e.g., MC module 130m may include any suitable monitoring module(s) or kiln rotation speed sensors or other information source(s) that may be operative to detect any suitable variable(s) 130v from kiln 124) and/or (ii) adjust any suitable kiln rotation speed variable(s) 130v of kiln 124 based on any suitable kiln apparatus controlling data 110a (e.g., MC module 130m may include any suitable controlling module(s), such as one or more rotational speed controller for kiln 124 (e.g., an SC, where a PID loop may be set up to control the rotational speed of kiln 124 (e.g., to between 45 and 67 rotations per hour)) that may be operative to adjust variable(s) 130v of kiln 124).

Additionally or alternatively, apparatus 103 (e.g., subsystem 111) may include a natural gas (“NG”) or any other suitable fuel source flow rate MC module 134m that may be configured to (i) detect any NG flow rate variable(s) 134v of a natural gas from a natural gas source 134 into kiln 124 (e.g., the flow rate of a NG valve of NG source 134 for kiln 124) for generating one or more NG flow rate variable components of kiln apparatus monitoring data 100a (e.g., MC module 134m may include any suitable monitoring module(s) or NG flow rate sensors or other information source(s) that may be operative to detect any suitable variable(s) 134v of natural gas from NG source 134 to kiln 124 (e.g., where the NG may provide fuel for kiln flame 124f)) and/or (ii) adjust any suitable NG flow rate variable(s) 134v of an NG valve of NG source 134 for kiln 124 based on any suitable kiln apparatus controlling data 110a (e.g., MC module 134m may include any suitable controlling module(s), such as one or more NG flow rate controllers for an NG valve of NG source 134 for kiln 124 (e.g., a flow control (“FC”), where a PID loop may be set up to control the flow of NG from NG source 134 into kiln 124) that may be operative to adjust variable(s) 134v of an NG valve of NG source 134 for kiln 124).

Additionally or alternatively, apparatus 103 (e.g., subsystem 111) may include a primary air (“PA”) flow rate MC module 136m that may be configured to (i) detect any PA flow rate variable(s) 136v of a primary air from a primary air source 136 into kiln 124 (e.g., the flow rate of a PA valve of PA source 136 for kiln 124) for generating one or more PA flow rate variable components of kiln apparatus monitoring data 100a (e.g., MC module 136m may include any suitable monitoring module(s) or PA flow rate sensors or other information source(s) that may be operative to detect any suitable variable(s) 136v of primary air from PA source 136 to kiln 124 (e.g., where the PA may reduce fuel for kiln flame 124f)) and/or (ii) adjust any suitable PA flow rate variable(s) 136v of a PA valve of PA source 136 for kiln 124 based on any suitable kiln apparatus controlling data 110a (e.g., MC module 136m may include any suitable controlling module(s), such as one or more PA flow rate controllers for a PA valve of PA source 136 for kiln 124 (e.g., an FC, where a PID loop may be set up to control the flow of PA from PA source 136 into kiln 124) that may be operative to adjust variable(s) 136v of a PA valve of PA source 136 for kiln 124).

Additionally or alternatively, apparatus 103 (e.g., subsystem 111) may include a primary air to natural gas (“ATG”) flow rate MC module 137m that may be configured to (i) detect any ATG flow rate variable(s) 137v of a ratio of primary air from PA source 136 into kiln 124 to natural gas from NG source 134 into kiln 124 (e.g., the ratio of a flow rate of a PA valve of PA source 136 for kiln 124 to a flow rate of an NG valve of NG source 134 for kiln 124) for generating one or more ATG flow rate variable components of kiln apparatus monitoring data 100a (e.g., MC module 137m may include any suitable monitoring module(s) or PA flow rate sensors and NG flow rate sensors or other information source(s) that may be operative to detect any suitable variable(s) 137v of a ratio of primary air from PA source 136 to kiln 124 and natural gas from NG source 134 to kiln 124) and/or (ii) adjust any suitable ATG flow rate variable(s) 137v of a PA valve of PA source 136 and of a NG valve of NG source 134 based on any suitable kiln apparatus controlling data 110a (e.g., MC module 137m may include any suitable controlling module(s), such as one or more PA flow rate controllers for a PA valve of PA source 136 for kiln 124 and/or one or more NG flow rate controllers for an NG valve of NG source 136 for kiln 124 (e.g., one or more FCs, where a PID loop may be set up to control the flow of PA from PA source 136 into kiln 124 and/or the flow of NG from NG source 134 into kiln 124 and/or) that may be operative to adjust variable(s) 137v of the PA and NG valves for kiln 124). It is to be understood that while natural gas is often mentioned, any other suitable fuel source may be used such that NG would be any suitable fuel and ATG would be air to fuel.

Additionally or alternatively, apparatus 103 (e.g., subsystem 111) may include a tertiary air source east fan rotation speed MC module 126m that may be configured to (i) detect any flow rate variable(s) 126v of tertiary air from a tertiary air source east 126 into kiln 124 (e.g., the flow rate of a valve of source 126 for kiln 124 or a fan speed of a fan between source 126 and kiln 124) for generating one or more tertiary air source east flow rate variable components of kiln apparatus monitoring data 100a (e.g., MC module 126m may include any suitable monitoring module(s) or tertiary air source east flow rate sensors or fan speed sensors and/or other information source(s) that may be operative to detect any suitable variable(s) 126v of tertiary air from tertiary air source east 126 to kiln 124) and/or (ii) adjust any suitable tertiary air source east flow rate variable(s) 126v of a valve of source 126 for kiln 124 based on any suitable kiln apparatus controlling data 110a (e.g., MC module 126m may include any suitable controlling module(s), such as one or more flow rate controllers for a valve of source 126 for kiln 124 and/or one or more speed controllers for a fan between source 126 and kiln 124 (e.g., an SC, where a PID loop may be set up to control the speed of a fan between source 126 and kiln 124) that may be operative to adjust variable(s) 126v flow of tertiary air from source 126 for kiln 124).

Additionally or alternatively, apparatus 103 (e.g., subsystem 111) may include a tertiary air source west fan rotation speed MC module 128m that may be configured to (i) detect any flow rate variable(s) 128v of tertiary air from a tertiary air source west 128 into kiln 124 (e.g., the flow rate of a valve of source 128 for kiln 124 or a fan speed of a fan between source 128 and kiln 124) for generating one or more tertiary air source west flow rate variable components of kiln apparatus monitoring data 100a (e.g., MC module 128m may include any suitable monitoring module(s) or tertiary air source west flow rate sensors or fan speed sensors and/or other information source(s) that may be operative to detect any suitable variable(s) 128v of tertiary air from tertiary air source west 128 to kiln 124) and/or (ii) adjust any suitable tertiary air source west flow rate variable(s) 128v of a valve of source 128 for kiln 124 based on any suitable kiln apparatus controlling data 110a (e.g., MC module 128m may include any suitable controlling module(s), such as one or more flow rate controllers for a valve of source 128 for kiln 124 and/or one or more speed controllers for a fan between source 128 and kiln 124 (e.g., an SC, where a PID loop may be set up to control the speed of a fan between source 128 and kiln 124) that may be operative to adjust variable(s) 128v flow of tertiary air from source 128 for kiln 124). In some embodiments, a tertiary air east and/or a tertiary air west may not be available for some kilns. However, this may be a design choice, as a kiln may be provided with one or more tertiary air fans or a primary fan or supplementary fans. A kiln may be provided with some ability to add air and/or oxygen (e.g., via fan(s)), for adding an appropriate amount of air/oxygen from each source (e.g., to optimize the real density while minimizing fuel and/or product loss). In some embodiments, a system may include an air or oxygen lance, which may be operative to introduce air and/or oxygen into the environment (e.g., introduce compressed air or oxygen into the environment through a water cooled lance). For example, module 126m may be one or more supplementary air/oxygen fan(s) (e.g., tertiary east/west fan(s)), while module 128 may be one or more air/oxygen lance(s).

Additionally or alternatively, apparatus 103 (e.g., subsystem 111) may include a firing hood draft MC module 138m that may be configured to (i) detect any firing hood draft variable(s) 138v of kiln 124 (e.g., the firing hood draft pressure of a firing hood of kiln 124) for generating one or more firing hood draft variable components of kiln apparatus monitoring data 100a (e.g., MC module 138m may include any suitable monitoring module(s) or firing hood draft sensors or pressure indicators (“PI”) and/or other information source(s) that may be operative to detect any suitable variable(s) 138v from kiln 124) and/or (ii) adjust any suitable firing hood draft variable(s) 138v of kiln 124 based on any suitable kiln apparatus controlling data 110a (e.g., MC module 138m may include any suitable controlling module(s), such as one or more firing hood draft pressure controllers for kiln 124 (e.g., a PI controller, where a PID loop may be set up to control the firing hood draft pressure of a firing hood of kiln 124) that may be operative to adjust variable(s) 138v of kiln 124).

Additionally or alternatively, apparatus 103 (e.g., subsystem 111) may include a burn zone temperature MC module 132m that may be configured to (i) detect any burn zone temperature variable(s) 132v of kiln 124 (e.g., the burn zone temperature of a portion of an interior of a vessel of kiln 124 (e.g., adjacent flame 124f)) for generating one or more burn zone temperature variable components of kiln apparatus monitoring data 100a (e.g., MC module 132m may include any suitable monitoring module(s) or burn zone temperature sensors or temperature indicators (“TI”) and/or other information source(s) that may be operative to detect any suitable variable(s) 132v from kiln 124) and/or (ii) adjust any suitable burn zone temperature variable(s) 132v of kiln 124 based on any suitable kiln apparatus controlling data 110a (e.g., MC module 132m may include any suitable controlling module(s), such as one or more burn zone temperature controllers for kiln 124 (e.g., a TI controller, where a PID loop may be set up to control the burn zone temperature of kiln 124 (e.g., to between 980° Celsius and 1,350° Celsius)) that may be operative to adjust variable(s) 132v of kiln 124). In some embodiments, burn zone temperature may not be controlled like fans or valves or through PIDs. Instead, burn zone temperature may be a controlled variable, where the temperature may be measured (e.g., using devices like thermocouples or pyrometers) and a change to that temperature may be carried out using the manipulated variables as handles. If the system wants to increase real density, it may want to see a higher burn zone temperature. To achieve this, the system may be configured to write a series of settings that may be equivalent to decreasing air/oxygen, closing the stack damper, and/or increasing natural gas, which is to be avoided when possible.

Additionally or alternatively, apparatus 103 (e.g., subsystem 111) may include a quench water (“QW”) flow rate MC module 142m that may be configured to (i) detect any QW flow rate variable(s) 142v of a quench water or other suitable fluid from a QW source 142 into kiln quench cooler 140 and/or onto conditioned material 139 (e.g., the flow rate of a QW valve of QW source 142 for cooler 140/material 139) for generating one or more QW flow rate variable components of kiln apparatus monitoring data 100a (e.g., MC module 142m may include any suitable monitoring module(s) or QW flow rate sensors or other information source(s) that may be operative to detect any suitable variable(s) 142v of QW from QW source 142 to cooler 140/material 139) and/or (ii) adjust any suitable QW flow rate variable(s) 142v of a QW valve of QW source 142 for cooler 140/material 139 based on any suitable kiln apparatus controlling data 110a (e.g., MC module 142m may include any suitable controlling module(s), such as one or more QW flow rate controllers for a QW valve of QW source 142 for cooler 140/material 139 (e.g., an FC, where a PID loop may be set up to control the flow of QW from QW source 142 for cooler 140/material 139) that may be operative to adjust variable(s) 142v of a QW valve of QW source 142 for cooler 140/material 139).

Additionally or alternatively, apparatus 103 (e.g., subsystem 111) may include a conditioned material rate MC module 144m that may be configured to (i) detect any suitable conditioned material rate variable(s) 144v of conditioned material weigh belt 144 (e.g., the rate of conditioned material 139 that may be introduced by belt 144 to cooler 140 (e.g., amount per time)) for generating one or more conditioned material rate variable components of kiln apparatus monitoring data 100a (e.g., MC module 144m may include any suitable monitoring module(s) or belt speed sensors or weight scales or other information source(s) that may be operative to detect any suitable variable(s) 144v from conditioned material weigh belt 144) and/or (ii) adjust any suitable conditioned material rate variable(s) 144v of belt 144 based on any suitable kiln apparatus controlling data 110a (e.g., MC module 144m may include any suitable controlling module(s), such as one or more speed controllers for belt 144 (e.g., an SC, where a PID loop may be set up to control the speed of belt 144) that may be operative to adjust variable(s) 144v of belt 144).

Additionally or alternatively, apparatus 103 (e.g., subsystem 111) may include a calcined material rate MC module 146m that may be configured to (i) detect any suitable calcined material rate variable(s) 146v of calcined material weigh belt 146 (e.g., the rate of calcined material 146 that may be removed by belt 146 from cooler 140 and/or from apparatus 107 (e.g., amount per time)) for generating one or more calcined material rate variable components of kiln apparatus monitoring data 100a (e.g., MC module 146m may include any suitable monitoring module(s) or belt speed sensors or weight scales or other information source(s) that may be operative to detect any suitable variable(s) 146v from calcined material weigh belt 146) and/or (ii) adjust any suitable calcined material rate variable(s) 146v of belt 146 based on any suitable kiln apparatus controlling data 110a (e.g., MC module 146m may include any suitable controlling module(s), such as one or more speed controllers for belt 146 (e.g., an SC, where a PID loop may be set up to control the speed of belt 146) that may be operative to adjust variable(s) 146v of belt 146).

For example, apparatus 103 (e.g., subsystem 118) may include a calcined material electrical resistivity (“ER”) MC module 147m that may be configured to detect any suitable calcined material electrical resistivity variable(s) 147v from calcined material 145 for generating one or more calcined material electrical resistivity variable components of kiln material monitoring data 100m (e.g., MC module 147m may include any suitable monitoring module(s) or ER measurement equipment (e.g., Ohmmeter) (e.g., for use according to the ISO 10143 standardized test method) or other information source(s) that may be operative to detect any suitable variable(s) 147v from calcined material 145). Electrical resistivity of anodes (e.g., anodes for the aluminium, steel, and/or titanium smelting industries) may depend on electrical properties of its constituents, of which carbon coke aggregates (e.g., calcined material 145 of system 1) may be the most prevalent. Therefore, the determination of the ER of calcined material 145 may be of significant importance to the management of system 1.

For example, apparatus 103 (e.g., subsystem 118) may include a calcined material real density (“RD”) MC module 148m that may be configured to detect any suitable calcined material real density variable(s) 148v from calcined material 145 for generating one or more calcined material real density variable components of kiln material monitoring data 100m (e.g., MC module 148m may include any suitable monitoring module(s) or RD measurement equipment (e.g., pycnometer or volumeter and balance, etc.) or other information source(s) that may be operative to detect any suitable variable(s) 148v (e.g., yield) from calcined material 145). The real density of calcined petroleum coke directly influences the physical and chemical properties of the manufactured carbon and graphite artifacts for which it may be used. Density, therefore, is a major quality specification of calcined petroleum coke (e.g., calcined material 145 of system 1) and may be of significant importance to the management of system 1 (e.g. may be used as a control in coke calcination).

Additionally or alternatively, apparatus 103 (e.g., subsystem 111) may include a blower air flow rate MC module 152m that may be configured to (i) detect any blower air flow rate variable(s) 152v of a blower air from a blower air source 152 into combustion chamber 150 (e.g., the flow rate of a blower air valve of blower air source 151 for chamber 150) for generating one or more blower air flow rate variable components of kiln apparatus monitoring data 100a (e.g., MC module 152m may include any suitable monitoring module(s) or blower air flow rate sensors or other information source(s) that may be operative to detect any suitable variable(s) 152v of blower air from blower air source 152 to chamber 150) and/or (ii) adjust any suitable blower air flow rate variable(s) 152v of a blower air valve of blower air source 152 for chamber 150 based on any suitable kiln apparatus controlling data 110a (e.g., MC module 152m may include any suitable controlling module(s), such as one or more blower air flow rate controllers for a blower air valve/louvre and motor speed of blower air source 152 for chamber 150 (e.g., an FC, where a PID loop may be set up to control the flow of blower air from blower air source 152 into chamber 150) that may be operative to adjust variable(s) 152v of a blower air valve/louvre and motor speed of blower air source 152 for chamber 150).

Additionally or alternatively, apparatus 103 (e.g., subsystem 111) may include a stack damper position MC module 154m that may be configured to (i) detect any stack damper position variable(s) 154v of stack damper 154 (e.g., the stack damper position of stack damper 154 with respect to combustion chamber 150) for generating one or more stack damper position variable components of kiln apparatus monitoring data 100a (e.g., MC module 154m may include any suitable monitoring module(s) or stack damper position sensors or output (“OP”) indicators and/or other information source(s) that may be operative to detect any suitable variable(s) 154v from stack damper 154) and/or (ii) adjust any suitable stack damper position variable(s) 154v of stack damper 154 based on any suitable kiln apparatus controlling data 110a (e.g., MC module 154m may include any suitable controlling module(s), such as one or more stack damper position controllers for stack damper 154 (e.g., an OP controller, where a PID loop may be set up to control the stack damper position of stack damper 154 with respect to combustion chamber 150) that may be operative to adjust variable(s) 154v of stack damper 154).

Additionally or alternatively, apparatus 103 (e.g., subsystem 111) may include a stack opacity MC module 156m that may be configured to (i) detect any stack opacity variable(s) 156v of an output of combustion chamber 150 (e.g., the stack opacity of chamber 150) for generating one or more stack opacity variable components of kiln apparatus monitoring data 100a (e.g., MC module 156m may include any suitable monitoring module(s) or stack opacity sensors or opacity indicators (“OIs”) and/or other information source(s) that may be operative to detect any suitable variable(s) 156v from combustion chamber 150) and/or (ii) adjust any suitable stack opacity variable(s) 156v of combustion chamber 150 based on any suitable kiln apparatus controlling data 110a (e.g., MC module 156m may include any suitable controlling module(s), such as one or more stack opacity controllers for combustion chamber 150 (e.g., an OI controller, where a PID loop may be set up to control the stack opacity of combustion chamber 150) that may be operative to adjust variable(s) 156v of stack damper 156). For example, there may be a relationship between chamber temperature and opacity. If a minimum temperature is maintained in the chamber, the opacity may be maintained. Typically, in the real world, opacity issues tend to occur when there is an upset (e.g., a sudden, unexpected change in the process, such as a plug or unexpected loss of power). Therefore, some locations may require or use a monitor, but are not needed and may be difficult to maintain.

Additionally or alternatively, apparatus 103 (e.g., subsystem 106) may include an ambient humidity MC module 160m that may be configured to (i) detect any ambient humidity variable(s) 160v of external environment 115 (e.g., the ambient humidity of a space external to kiln apparatus 107) for generating one or more ambient humidity variable components of external environment monitoring data 100e (e.g., MC module 160m may include any suitable monitoring module(s) or ambient humidity sensors and/or other information source(s) that may be operative to detect any suitable variable(s) 160v from environment 115) and/or (ii) adjust any suitable ambient humidity variable(s) 160v of environment 115 based on any suitable external environment controlling data 110e (e.g., MC module 160m may include any suitable controlling module(s), such as one or more ambient humidity controllers for environment 115 (e.g., a humidifier controller, where a PID loop may be set up to control the ambient humidity of environment 115) that may be operative to adjust variable(s) 160v of environment 115). Ambient humidity may be monitored and the model may be configured to use that information to optimize kiln operation but the system may or may not be configured to control ambient humidity (e.g., with an HVAC or the like).

Additionally or alternatively, apparatus 103 (e.g., subsystem 106) may include an ambient temperature MC module 162m that may be configured to (i) detect any ambient temperature variable(s) 162v of external environment 115 (e.g., the ambient temperature of a space external to kiln apparatus 107) for generating one or more ambient temperature variable components of external environment monitoring data 100e (e.g., MC module 162m may include any suitable monitoring module(s) or ambient temperature sensors and/or other information source(s) that may be operative to detect any suitable variable(s) 162v from environment 115) and/or (ii) adjust any suitable ambient temperature variable(s) 162v of environment 115 based on any suitable external environment controlling data 110e (e.g., MC module 162m may include any suitable controlling module(s), such as one or more ambient temperature controllers for environment 115 (e.g., an HVAC controller, where a PID loop may be set up to control the ambient temperature of environment 115) that may be operative to adjust variable(s) 162v of environment 115). Ambient temperature may be monitored and the model may be configured to use that information to optimize kiln operation but the system may or may not be configured to control ambient temperature (e.g., with an HVAC or the like). Additionally or alternatively, ambient wind speed may be monitored and the model may be configured to use that information to optimize kiln operation but the system may or may not be configured to control ambient wind speed (e.g., with ambient fans or the like).

It is to be understood that many other kinds of kiln management variables of a kiln apparatus and/or of materials processed and/or produced by a kiln apparatus and/or of environment(s) external to a kiln apparatus may be monitored by system 1 in any suitable way(s) and/or controlled by system 1 in any suitable way(s) and ought not be limited to only those explicitly described herein (e.g., vibrated bulk density (“VBD”), temperature in flow meter readings, etc.).

Different kiln management variables may be monitored and/or controlled at different frequencies depending on their characteristics and/or relationship with other system components and/or how they may be used by the system. For example, some kiln management variables may be associated with MC modules that may be configured to rapidly monitor and/or control a variable (e.g., continuously or in real-time or substantially real-time), such as flow rate modules, fan speed modules, kiln rotation speed variables, draft variables, material rate variables, position variables, material quality variables, and/or the like that may be under control of a management entity of the kiln apparatus and kiln materials. The frequency of such variable monitoring and/or controlling may be any suitable frequency that may be possible given system constraints, but may be substantially live, such as every 0.25 seconds or any other suitable frequency, which may be determined based on any suitable characteristics (e.g., temperature(s), air pressure, water pressure, etc.). These kiln management variables that may be monitored and/or controlled at such a high frequency may include feed material rate variable(s) 120v, tertiary air source east flow rate/fan rotation speed variable(s) 126v, tertiary air source west flow rate/fan rotation speed variable(s) 128v, kiln rotation speed variable(s) 130v, burn zone temperature variable(s) 132v, natural gas flow rate variable(s) 134v, primary air flow rate variable(s) 136v, primary air to natural gas flow rate ratio variable(s) 137v, firing hood draft variable(s) 138v, quench water flow rate variable(s) 142v, conditioned material rate variable(s) 144v, calcined material rate variable(s) 146v, blower air flow rate variable(s) 152v, stack damper position variable(s) 154v, stack opacity variable(s) 156v, and/or raw feed material quality variable(s) 158). Therefore, an ability to measure and/or control certain kiln management variables autonomously and constantly/live may be valuable to the functionality of the system. As an example, air flow is an important part of a calcination process by a kiln. Therefore, an emphasis may be placed on identifying and deploying in the system the most reliable and accurate flow meters for detecting certain kiln management variables (e.g., monitoring variable(s) 126v, 128v, 134v, 136v, 137v, 142v, 152v, and/or the like). Similarly, fan MC modules may be identified and deployed in the kiln that may be accurately and reliably controlled by the system (e.g., by controlling data and/or HMIs). The rapid, accurate, and reliable measurement and control of fluid movement within the system enables efficient and effective automation of kiln variable management. The same may be said for other types of variable measurement and control (e.g., burn zone temperature).

Alternatively, some other kiln management variables may be associated with MC modules that may be configured to less rapidly monitor and/or control a variable (e.g., every 15 minutes or so), such as ambient humidity modules, ambient temperature modules, other external environment modules, and/or the like that may or may not be under control of a management entity of the kiln apparatus and kiln materials. The frequency of such variable monitoring and/or controlling may be any suitable frequency that may be possible given system constraints, but may or may not be substantially live, such as every 0.25 seconds if live or significantly less frequently, such as every 5 to 15 minutes for less variable and/or less controlled variables (e.g., external temperature, external humidity, etc. (e.g., ambient humidity variable(s) 160v, ambient temperature variable(s) 162v, etc.)).

Alternatively, some other kiln management variables may be associated with MC modules that may be configured to monitor a variable even less often (e.g., every 1 hour or ever 3 to 6 hours or in response to the occurrence of a particular event (e.g., lab availability, raw feed change, etc.)), such as calcined material characteristic modules (e.g., calcined material electrical resistivity modules (e.g., for calcined material ER variable(s) 147v), calcined material real density modules (e.g., for calcined material RD variable(s) 148v), and/or the like) that may be dependent upon a time-consuming and/or costly material analysis process. The frequency of such variable monitoring and/or controlling may be any suitable frequency that may be possible given system constraints. For example, to carry out calcined material characteristic analysis (e.g., with subsystem 118), the calcined material (e.g., material 145) may have to be specially processed or prepared for specific analysis (e.g., separated, crushed, turned into pellets, and analyzed by a particular machine or set of process steps in a laboratory that may not be implemented intimately with other kiln apparatus (e.g., unlike a flow meter and/or temperature meter with kiln 124)). Such an analysis process may be time consuming and/or expensive, thereby lending itself to a less frequent occurrence. However, in some embodiments, a more frequent (e.g., substantially real-time) analysis/monitoring of calcined material characteristic(s) may be achieved. For example, if the time to physically prepare the samples and if the time to perform the test itself were to be reduced to instantaneous or substantially instantaneous, then these values may be treated like any other controlled variable (e.g., like burn zone temperature). However, when these values are not available instantaneously and instead after some delay, the software of the system may be especially useful.

Alternatively, some other kiln management variables may be associated with MC modules that may be configured to monitor and/or control a variable at the occurrence of a specific event. For example, in some embodiments, a raw feed material quality variable 158v may only be monitored in response to a specific event (e.g., every time a blend/feed component is changed for the source of raw feed material 121), rather than constantly monitoring the material quality of a raw feed material that is being supplied by a static feed source. A target real density may be event based, such as like the blends, which may be set in subsystem 119 and passed to subsystem 116. If the blend and/or target real density may change, such information may be updated in subsystem 119 and passed through subsystem 116 to subsystem 113 and then to server 114.

Different kiln management variables may be referred to herein and/or designated as a particular variable type of various types, including, but not limited to, a controlled variable (“CV”), a manipulated variable (“MV”), a disturbance variable (“DV”), an inferential variable (“IV”), and/or the like. For example, manipulated variables may be variables that may be changed to affect other variables, such as controlled variables, while, conversely, controlled variables may be variables that may be controlled by adjusting one or more manipulated variables. For example, kiln management variables of system 1 that may be considered MVs may include, but are not limited to, tertiary air source east fan rotation speed variable 126v, tertiary air source west fan rotation speed variable 128v, kiln rotation speed variable 130v, natural gas flow rate variable 134v, primary air flow rate variable 136v, quench water flow rate variable 142v, blower air flow rate variable 152v, and/or stack opacity variable 156v, while kiln management variables of system 1 that may be considered CVs may include, but are not limited to, burn zone temperature variable 132v and/or primary air to natural gas flow rate ratio variable 137v. For example, MV natural gas flow rate variable 134v and/or MV primary air flow rate variable 136v may be changed to affect CV primary air to natural gas flow rate ratio variable 137v. As another example, tertiary air source fan rotation speed variable(s) MV 126v and/or MV 128v and/or kiln rotation speed variable MV 130v may be changed to affect CV burn zone temperature variable 132v. Inferential variables may be a special type of controlled variable, where a value of an inferential variable may not be constantly or continuously known or monitored, and, therefore, the system may be configured to predict the value of the inferential variable based on historical behavior (e.g., along with real-time learning). For example, kiln management variables of system 1 that may be considered IVs may include, but are not limited to, calcined material electrical resistivity variable 147v and/or calcined material real density variable 148v.

Additionally or alternatively, disturbance variables may be variables that may not be controlled by the model but that can influence the process and/or that can be considered by the model in the design of the system (e.g., ambient temperature). For example, kiln management variables of system 1 that may be considered DVs may include, but are not limited to, feed material rate variable 120v, firing hood draft variable 138v, conditioned material rate variable 144v, calcined material rate variable 146v, stack damper position variable 154v, raw feed material quality variable 158v, ambient humidity variable 160v, and/or ambient temperature variable 162v. In some embodiments, a variable may be treated as a DV because the designer may want the freedom to change it. For example, the model may be trained to optimize around a condition (e.g., on a very hot day, the kiln may not need as much gas to heat the material, and the model may be configured to know that “today is a hot day, so that information will be used when deciding how much gas to add”). As an external ambient temperature may not be changed by the system, the system may use the known external ambient temperature to determine a particular model to use or to use a model in a particular way to achieve a particular result. For example, feed material rate variable 120v may be treated as a DV so the model may consider it in a control algorithm. Feed material rate variable 120v may be determined by a permit (e.g., a specific recipe being run may dictate a maximum operational speed, therefore, instead of letting the model decide how fast to operate, the recipe being run may be operative to decide, such that the model may be told or configured to understand or learn that “this is the defined feed rate, deal with it,” and the model may optimize based on the actual feed rate). Firing hood draft variable 138v may be a DV because it may not be controlled by an operator but may be known how it affects a process of the system. Conditioned material rate variable 144v and/or calcined material rate variable 146v may be a DV because we may be feeding material into one end of a gravity fed system and I may be coming out the other end, whereby a calcined belt rate may be configured to remove the material fast enough so that the belt weight capacity is not exceeded, such that there may be a defined relationship between the feed in rate and the removal (calcined) rate. Stack damper position variable 154v may be an MV when a relationship is understood between stack damper position and RD and/or ER. Raw feed material quality variable 158v may be considered a DV as there may not be enabled the ability to decide exactly what is to be fed into the kiln and so it may not be desirable to have the model dependent on the feed qualities, such that, instead, it may be configured to react to the feed quality(ies). In some kiln systems, stack damper position variable 154v may be treated as an MV rather than as a DV. For example, in one location, operators may rarely change the stack damper position, such that when a model was trained on many years of data, there may not be a way to determine the relationship between stack damper position and anything else (e.g., temperature, etc.). To get around this lack of data, stack damper position may be made a DV. Although, in other instances, stack damper position may be an MV.

Processor assembly 12 of KVMS subsystem 108 (e.g., of kiln model server 114) may include any processing circuitry that may be operative to control the operations and performance of one or more assemblies of system 1. For example, processor assembly 12 may be used to run one or more applications, such as an application 19. Application 19 may include, but is not limited to, one or more operating system applications, firmware applications, state determination applications, thermal management applications, kiln management applications, and/or any other suitable applications. For example, processor assembly 12 may load application 19 as a kiln management program to determine how instructions or data received via any suitable source (e.g., data 100a from subsystem 102, data 100m from subsystem 104, data 100e from subsystem 106) may manipulate the one or more ways in which information may be stored on subsystem 108 and/or provided as an output to any suitable destination (e.g., data 110a to subsystem 102, data 110m to subsystem 104, data 110e to subsystem 106). Application 19 may be accessed by processor assembly 12 from any suitable source, such as from memory assembly 13 (e.g., via bus 18) or from another remote subsystem or server. Processor assembly 12 may include a single processor or multiple processors. For example, processor assembly 12 may include at least one “general purpose” microprocessor, a combination of general and special purpose microprocessors, instruction set processors, graphics processors, video processors, and/or related chips sets, and/or special purpose microprocessors. Processor assembly 12 also may include on board memory for caching purposes.

One particular type of application available to processor assembly 12 may be a kiln management application 19a that may be operative to determine or predict a current or future output of kiln apparatus 107. Such an output may be determined by kiln management application 19a based on any suitable data accessible by kiln management application 19a (e.g., from memory assembly 13 and/or from any suitable remote entity (e.g., subsystem 102, subsystem 104, subsystem 106, etc.)), such as data 100a, data 100m, data 100e from any suitable data source and/or any suitable kiln management model data of any suitable kiln management model 19m, and/or the like. For example, at a particular time, such a kiln management application 19a may be operative to determine or predict one or more outputs of kiln apparatus 107 or otherwise of system 1.

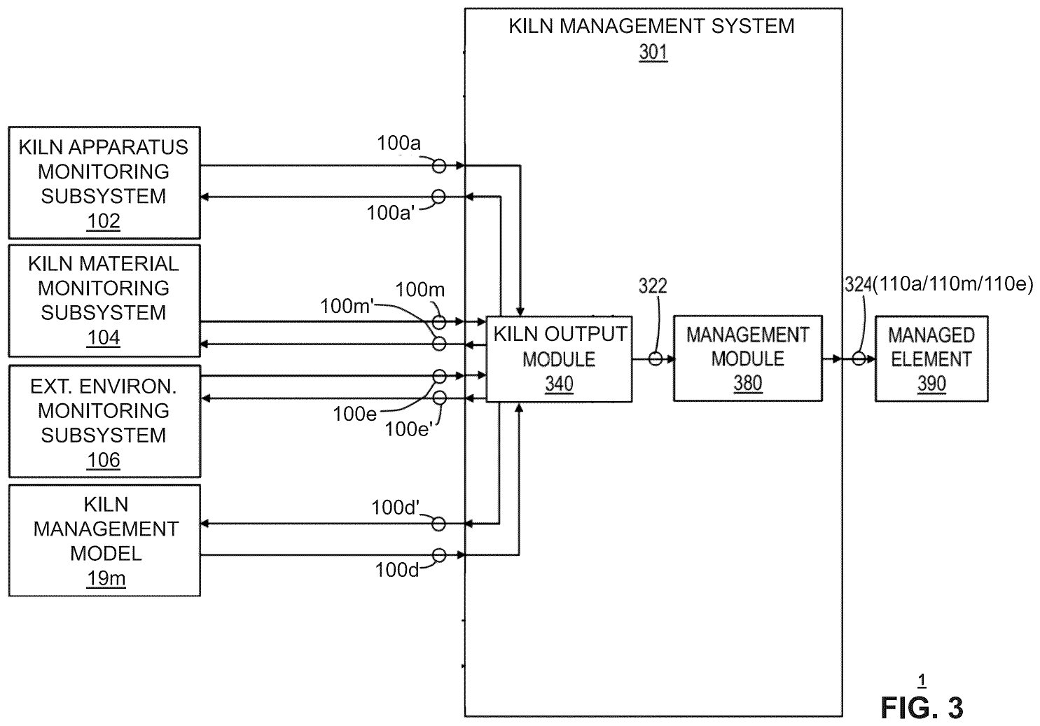

Processor assembly 12 of KVMS subsystem 108 (e.g., of kiln model server 114) or of any other suitable subsystem of system 1 (e.g., subsystem 102 if a kiln management model may be managed on such a subsystem) may load any suitable application 19a as a background application program or a user-detectable application program in conjunction with any suitable kiln management model 19m to determine how any suitable input assembly data received may be used to determine any suitable kiln output product state data (e.g., kiln output product state data 322 of FIG. 3) that may be used to control or manipulate at least one functionality of system 1 (e.g., a performance or mode of kiln apparatus 107 and/or subsystem 111 and/or subsystem 118 and/or subsystem 106 that may be altered in a particular one of various ways (e.g., particular kiln management alerts or recommendations may be provided to a user via a user interface assembly (e.g., subsystem 112, etc.) and/or particular kiln management adjustments may be made by an output assembly and/or the like (e.g., by subsystem 111, etc.))). Any suitable kiln management model or any suitable combination of two or more kiln management models may be used by subsystem 108 in order to make any suitable kiln output product state determination/prediction for any particular kiln of system 1 at any particular time (e.g., any kiln management model(s) 19m may be used in conjunction with any suitable kiln apparatus monitoring data 100a from subsystem 102 and/or in conjunction with any suitable kiln material monitoring data 100m from subsystem 104 and/or in conjunction with any suitable external environment monitoring data 100e from subsystem 106 to provide any suitable kiln output product state data that may be indicative of any suitable kiln output product variable(s) for the particular kiln at the particular time). For example, a kiln management model 19m may be maintained and updated on subsystem 108 (e.g., on kiln model server 114 (e.g., in memory assembly 13)) using processing capabilities of processor assembly 12. Additionally or alternatively, an auxiliary kiln management model 19ma may be maintained and updated by any suitable auxiliary kiln management subsystem that may include any suitable assemblies, such as assemblies that may be similar to one, some, or each of the assemblies of subsystem 108 (e.g., one or more of subsystems 102, 104, and 106 and/or any other auxiliary model management subsystem that may not be shown), where model 19ma may be communicated to subsystem 108 (e.g., server 114) (e.g., for use by application 19a instead of or in addition to (e.g., as a supplement to) kiln management model 19m, or may be used locally on that auxiliary kiln management subsystem in place of subsystem 108).

A kiln management model may be developed and/or generated for use in evaluating and/or predicting a kiln output product state for a particular kiln (e.g., at a particular time and/or with respect to one or more particular activities). For example, a kiln management model may be a learning engine for an experiencing entity (e.g., a particular kiln or a particular subset or type of kiln or all kilns generally), where the learning engine may be operative to use any suitable machine learning (“ML”) (e.g., the system's ability to learn automatically from past events to affect future behavior) to use certain monitored system data (e.g., one or more types or categories or components of any suitable kiln apparatus monitoring data 100a from subsystem 102 and/or of certain kiln material monitoring data 100m from subsystem 104 (e.g., data 100m indicative of raw feed material quality variable 158v) and/or of any suitable external environment monitoring data 100e from subsystem 106) for a particular environment (e.g., at a particular time and/or with respect to one or more planned activities) in order to predict, estimate, and/or otherwise generate a kiln output product state that may be indicative of the kiln status of the particular experiencing entity kiln (e.g., a kiln output level that may be derived by the kiln at that moment (e.g., a kiln material variable or kiln material variables of a finished product generated by the kiln)). For example, the learning engine may include any suitable neural network (e.g., an artificial neural network) that may be initially configured, trained on one or more sets of monitored system data (e.g., any suitable monitored data 100a, data 100m, and/or data 100e for any suitable monitored variables) that is associated with known or otherwise determined or confirmed finished product/material quality data 100m (e.g., known data for variable 147v and/or variable 148v and/or otherwise of calcined material 145) from any suitable kiln(s), and then used to predict finished product/material quality data (e.g., data for variable 147v and/or variable 148v) or any other suitable kiln output product state based on another set of monitored system data.

A neural network or neuronal network or artificial neural network may be hardware-based, software-based, or any combination thereof, such as any suitable model (e.g., an analytical model, a computational model, etc.), which, in some embodiments, may include one or more sets or matrices of weights (e.g., adaptive weights, which may be numerical parameters that may be tuned by one or more learning algorithms or training methods or other suitable processes) and/or may be capable of approximating one or more functions (e.g., non-linear functions or transfer functions) of its inputs. The weights may be connection strengths between neurons of the network, which may be activated during training and/or prediction. A neural network may generally be a system of interconnected neurons that can compute values from inputs and/or that may be capable of machine learning and/or pattern recognition (e.g., due to an adaptive nature). A neural network may use any suitable machine learning techniques to optimize a training process. The neural network may be used to estimate or approximate functions that can depend on a large number of inputs and that may be generally unknown. The neural network may generally be a system of interconnected “neurons” that may exchange messages between each other, where the connections may have numeric weights (e.g., initially configured with initial weight values) that can be tuned based on experience, making the neural network adaptive to inputs and capable of learning (e.g., learning pattern recognition). A suitable optimization or training process may be operative to modify a set of initially configured weights assigned to the output of one, some, or all neurons from the input(s) and/or hidden layer(s). A non-linear transfer function may be used to couple any two portions of any two layers of neurons, including an input layer, one or more hidden layers, and an output (e.g., an input to a hidden layer, a hidden layer to an output, etc.).

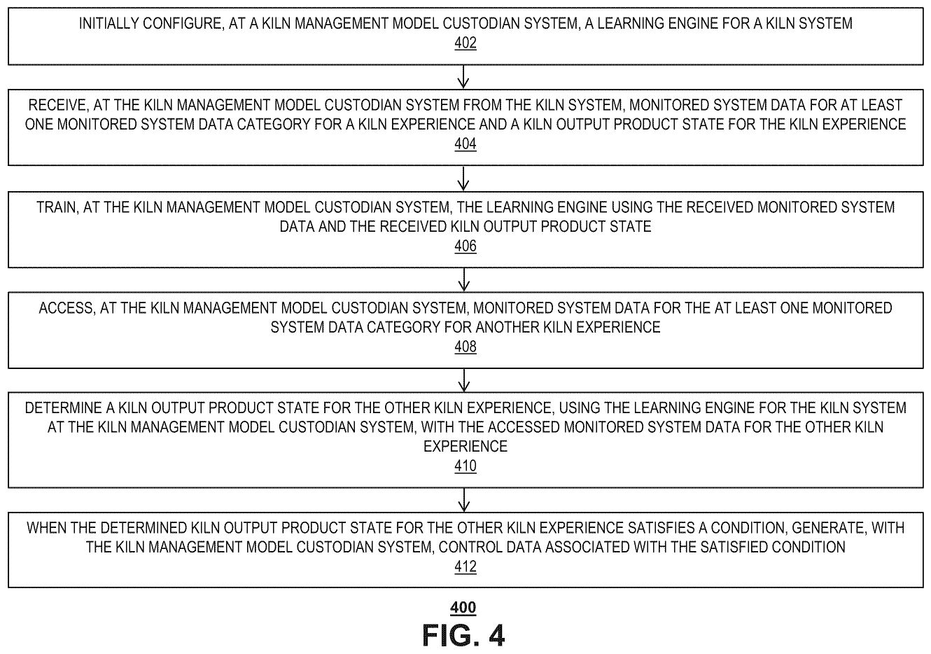

Different input neurons of the neural network may be associated with respective different types of monitored system data categories and may be activated by monitored system data of the respective monitored system data categories (e.g., each possible category of monitored system data variable information (e.g., raw feed material weigh belt rate, conditioned material weigh belt rate, calcined material weigh belt rate, natural gas flow rate, air flow rate(s), kiln rotation speed, blower air flow rate, quench water flow rate, stack opacity, firing hood draft, burn zone temperature, stack damper position, etc. of any suitable kiln apparatus monitoring data 100a from subsystem 102 and/or raw feed material quality of raw feed material, electrical resistivity of calcined material, real density of calcined material, etc. of any suitable kiln material monitoring data 100m from subsystem 104 and/or ambient humidity, ambient temperature, etc. of any suitable external environment monitoring data 100e from subsystem 106) may be associated with one or more particular respective input neurons of the neural network and monitored system data for the particular monitored system data category may be operative to activate the associated input neuron(s)). The weight assigned to the output of each neuron may be initially configured (e.g., at operation 402 of process 400 of FIG. 4) using any suitable determinations that may be made by a custodian or processor of the kiln management model (e.g., subsystem 108 (e.g., server 114)) based on the data available to that custodian.

The initial configuring of the learning engine or kiln management model for a particular kiln (e.g., the initial weighting and arranging of neurons of a neural network of the learning engine) may be done using any suitable data accessible to a custodian of the kiln management model (e.g., a manufacturer of subsystem 108 or of a portion thereof (e.g., server 114, kiln management model 19m, etc.), any suitable maintenance entity that manages subsystem 108, and/or the like), such as data associated with the configuration of other learning engines of system 1 (e.g., learning engines or kiln management models for other kilns), data associated with the particular kiln (e.g., initial background data accessible by the model custodian about the particular kiln's composition, location, past uses, and/or the like), data assumed or inferred by the model custodian using any suitable guidance, and/or the like. For example, a model custodian may be operative to capture any suitable initial background data about a particular kiln in any suitable manner, which may be enabled by any suitable user interface provided to an appropriate subsystem or device accessible to one, some, or each operator or entity with knowledge of the particular kiln (e.g., a model app or website). The model custodian may provide a data collection portal for enabling any suitable entity to provide initial background data for the particular kiln. The data may be uploaded in bulk or manually entered in any suitable manner. In a particular embodiment, the following is a list of just some of the one or more potential types of data that may be collected by a model custodian (e.g., for use in initially configuring the model): sample questions for which answers may be collected may include, but are not limited to, questions related to its parts (e.g., weight, size, shape, composition of kiln 124, etc.), preferred ambient temperature or temperature range, preferred ambient humidity or humidity range, and/or the like.

In some embodiments, a large set of data (e.g., four years worth of data) may be used and behaviors may be selected that are sought to be automated (e.g., through AI). For example, data that represented kiln start up or shut down may be removed because that may not be the behavior sought to train the model to run. Additionally or alternatively, representative samples of MVs actually being manipulated may be wanted so the model could learn the relationship between that variable(s) and the CVs. So, if it was wanted to allow gas flows between X and Y, data sets that included historical operation at and between X and Y may be used. In the case of stack damper position, because the stack damper was never moved during the operation of a particular kiln, that kiln did not have historical data to train stack damper position as an MV so it may be treated as a DV. However, once enough data was able to be collected, the system was able to change stack damper position to an MV. A data warming process may be used when enough information on a relationship is not available, where an MV may be specifically changed to a value and then the operators may work the other handles to optimize. In this way, the model may be able to learn the relationship(s).

A kiln management model custodian may receive (e.g., at operation 404 of process 400 of FIG. 4) not only monitored system data for at least one monitored system data category for a particular kiln experience (e.g., for a kiln operating in a particular environment at a particular moment in time) but also a kiln output product state for that kiln experience (e.g., a kiln output material status of the particular kiln experience (e.g., a kiln output level derived by the kiln in that particular kiln experience (e.g., a kiln material variable or kiln material variables of a finished product generated by the kiln in that particular kiln experience (e.g., data for variable 147v and/or variable 148v and/or the like of calcined product 145)))). This may be enabled by monitoring any suitable system data for a kiln, inclusive of one or more kiln finished product material variables (e.g., monitored data of variable 147v and/or of variable 148v). The kiln management model custodian may provide a data collection portal for enabling any suitable entity(ies) to provide such data. The kiln output product state (e.g., kiln finished product material variable(s)) generated by the kiln in that particular kiln experience) may be received and may be derived from the kiln in any suitable manner (e.g., by subsystem 118, subsystem 119, etc.), while the other associated monitored system data may be similarly derived from the kiln (e.g., by subsystem 111, subsystem 112, subsystem 118, subsystem 119, subsystem 106, etc.). In some embodiments, useful training data that has not only kiln apparatus monitored data and external environment monitored data but also kiln finished product monitored data that is properly associated (e.g., in time) with the other monitored data of the training data may be obtained if/when one, some, or each data point has an associated date/time stamp so they can be correlated. The model itself may be configured to determine whether a data result is leading/lagging (e.g., an appropriate time delay may be used to transpose the two types of data so that they are properly associated with each other for training purposes (e.g., the ER and RD of calcined coke released by the cooler at time X should be associated with temperature/humidity/kiln speed data captured at time X minus 5 minutes)).

A learning engine or comfort model for a kiln may be trained (e.g., at operation 406 of process 400 of FIG. 4) using the received monitored system data for the kiln experience (e.g., as inputs of a neural network of the learning engine) and using the received kiln output product state for the kiln experience (e.g., as an output of the neural network of the learning engine). Any suitable training methods or algorithms (e.g., learning algorithms) may be used to train the neural network of the learning engine, including, but not limited to, Back Propagation, Resilient Propagation, Genetic Algorithms, Simulated Annealing, Levenberg, Nelder-Meade, and/or the like. Such training methods may be used individually and/or in different combinations to get the best performance from a neural network. A loop (e.g., a receipt and train loop) of receiving monitored system data and a kiln output product state for a kiln experience (e.g., a particular kiln in a particular environment at a particular moment) and then training the kiln model using the received monitored system data and kiln output product state (e.g., a loop of operation 404 and operation 406 of process 400 of FIG. 4) may be repeated any suitable number of times for the same kiln(s) in different kiln experiences (e.g., in same or different environments at different moments) and the same learning engine for more effectively training the learning engine for the kiln, where the received monitored system data and the received kiln output product state of different receipt and train loops may be for different environments or for the same environment (e.g., at different times and/or with respect to different planned activities) and/or may be received from the same source or from different sources of the kiln (e.g., from different monitoring modules of the kiln/environment) (e.g., a first receipt and train loop may include receiving monitored system data and a kiln output product state from a kiln system with respect to a kiln in a first kiln experience (e.g., in a first environment in a first moment), while a second receipt and train loop may include receiving monitored system data and a kiln output product state from a kiln system with respect to that same kiln in a second kiln experience (e.g., in the first environment in a second moment), while a third receipt and train loop may include receiving monitored system data and a kiln output product state from a kiln system with respect to another kiln in a third kiln experience (e.g., in the first environment or another second environment at any moment in time), and/or the like), while the training of different receipt and train loops may be done for the same learning engine using whatever monitored system data and kiln output product state was received for the particular receipt and train loop. The number and/or type(s) of the one or more monitored system data categories for which monitored system data may be received for one receipt and train loop may be the same or different in any way(s) than the number and/or type(s) of the one or more monitored system data categories for which monitored system data may be received for a second receipt and train loop.

A trained model may then receive input data from any suitable source using any suitable methods for use by the model. The trained model may then use this new input data to generate output data using the learning engine or model. For example, the new input data may be utilized as input(s) to the neural network of the learning engine similarly to how other input data accessed for a receipt and train loop may be utilized as input(s) to the neural network of the learning engine at a training portion of the receipt and train loop, and such utilization of the learning engine with respect to the new input data may result in the neural network providing an output indicative of data that may represent the learning engine's predicted or estimated result.

The processing power and speed of the KVMS and its various models may be configured to determine continuously an updated kiln output product state of a kiln system and present associated information or otherwise adjust a managed element based on the determined kiln output product state automatically and instantaneously or substantially instantaneously based on any new received monitored system data that may be generated by the kiln system, such that management of the kiln system may run quickly and smoothly. This may enable the kiln system to operate as effectively and as efficiently as possible.

A kiln management model custodian may access (e.g., at operation 408 of process 400 of FIG. 4) monitored system data for at least one monitored system data category for another kiln experience (e.g., a kiln experience that is different than any kiln experience considered at any monitored kiln system data receipt and train loop for training the learning engine). In some embodiments, this other kiln experience may be a kiln experience that has not been specifically experienced by any kiln prior to use of the kiln management model in an end user use case (e.g., at operation 408). Although, it is to be understood that this other kiln experience may be any suitable kiln experience (e.g., any suitable set of circumstances for a kiln and its environment). The monitored system data for this other kiln experience may be accessed from or otherwise provided by any suitable source(s) using any suitable methods (e.g., from one or more MC modules and/or input assemblies of any suitable subsystems of system 1 that may be associated with the particular kiln during the particular kiln experience) for use by the kiln management model custodian (e.g., processor assembly 12 of server 114).

This other kiln experience (e.g., kiln experience of interest) may then be scored/have its kiln output product state be determined (e.g., at operation 410 of process 400 of FIG. 4) using the learning engine or kiln management model for the kiln with the monitored system data accessed for such another kiln experience. For example, the monitored system data accessed for the kiln experience of interest may be utilized as input(s) to the neural network of the learning engine (e.g., at operation 410 of process 400 of FIG. 4) similarly to how the monitored system data accessed at a receipt portion of a receipt and train loop may be utilized as input(s) to the neural network of the learning engine at a training portion of the receipt and train loop, and such utilization of the learning engine with respect to the monitored system data accessed for the kiln experience of interest may result in the neural network providing an output indicative of a kiln output product state that may represent the learning engine's predicted or estimated kiln output product state to be derived from the kiln in the kiln experience of interest.

After a kiln output product state (e.g., any suitable kiln output product state data (e.g., kiln output product state data 322 of FIG. 3)) is realized for an kiln experience of interest (e.g., for a current environment being experienced by a kiln (e.g., in a particular moment and/or during a particular planned activity)), it may be determined (e.g., at operation 412 of process 400 of FIG. 4) whether the realized kiln output product state satisfies a particular condition of any suitable number of potential conditions and, if so, the model custodian or any other suitable processor assembly or otherwise (e.g., of subsystem 108 or otherwise) may generate any suitable control data (e.g., kiln management mode data (e.g., kiln management mode data 324 of system 301 of FIG. 3)) that may be associated with that satisfied condition for controlling any suitable functionality of any suitable output assembly of system 1 or otherwise (e.g., for adjusting a user interface presentation to a user (e.g., to provide a kiln management suggestion or predicted kiln output product state), such as to an operator 109 via subsystem 112, and/or for controlling any suitable functionality of any suitable MC module of system 1 (e.g., any suitable MC module of subsystem 102 by sending any suitable data 110a and/or any suitable MC module of subsystem 104 by sending any suitable data 110m and/or any suitable MC module of subsystem 106 by sending any suitable data 110e) that may adjust any suitable functionality or characteristic(s) of kiln apparatus 107 and/or its external environment 115 (e.g., increase the natural gas flow rate, reduce the kiln rotation speed, adjust the quality of the raw feed material, etc.), and/or for controlling any suitable functionality of any suitable sensor assembly of system 1 or otherwise (e.g., for turning on or off a particular type of sensor and/or for adjusting the functionality (e.g., the accuracy) of a particular type of sensor (e.g., to gather any additional suitable sensor data)), and/or the like). For example, a particular condition may be a minimum threshold value of a kiln output product state (e.g., a value of a variable 147v and/or of a variable 148v of a kiln output product state) below which the predicted kiln output product state ought to result in a warning or other suitable instruction or system controlling data (e.g., data 110) being provided with respect to the unsuitability of the kiln experience of interest (e.g., an instruction to shut down or manually adjust or automatically adjust the system). A threshold value of a kiln output product state may be determined in any suitable manner and may vary between different kilns and/or between different kiln experiences of interest and/or between different combinations of such kilns and environments of kiln experiences in any other suitable manner.

If an actual kiln output product state is determined for the kiln experience of interest, then any suitable actual kiln output product state data (e.g., any suitable kiln material monitoring data 100m that may be indicative of any suitable characteristic(s) of any suitable kiln output product material(s) (e.g., electrical resistivity of calcined material, real density of calcined material, etc.)) may be received by the model and may be used in an additional receipt and train loop for further training the learning engine. Moreover, in some embodiments, a kiln management model custodian may be operative to compare a predicted kiln output product state for a particular kiln experience of interest with an actual kiln output product state detected for the kiln experience of interest that may be received after or while the kiln may be actually experiencing the kiln experience of interest and enabled to actually predict the kiln output product state. Such a comparison may be used in any suitable manner to further train the learning engine and/or to specifically update certain features (e.g., weights) of the learning engine. For example, any algorithm or portion thereof that may be utilized to determine a kiln output product state may be adjusted based on the comparison. An operator may be enabled by the kiln management model custodian to adjust one or more filters, such as a profile of preferred environments and/or preferred kiln output product state data variables and/or preferred kiln settings and/or the like in order to achieve such results. This capability may be useful based on changes in a kiln's capabilities and/or objectives as well as the kiln output product state results. For example, if a kiln loses its ability to rotate above a certain speed, this information may be provided to the model custodian, whereby one or more weights of the model may be adjusted such that the model may provide appropriate kiln output product states and/or appropriate controlling data in the future.

Therefore, any suitable kiln management model custodian may be operative to generate and/or manage any suitable kiln management model or kiln management learning engine that may utilize any suitable machine learning, such as one or more artificial neural networks, to analyze certain monitored system data of a kiln system to predict/estimate a kiln output product state of the kiln system (e.g., generally, and/or in a particular kiln experience), which may enable intelligent suggestions to be provided to an operator and/or intelligent system functionality adjustments to be made for improving the operator's experiences and the kiln system's productivity. For example, a kiln management engine may be initially configured or otherwise developed for a kiln based on information provided to a model custodian by the kiln system that may be indicative of the kiln system's specific preferences or operator requirements and/or of the kiln system's specific experience with one or more specific environments. An initial version of the kiln management engine for the kiln system may be generated by the model custodian based on certain assumptions made by the model custodian, perhaps in combination with some limited kiln-specific information that may be acquired by the model custodian from the kiln system prior to using the kiln management engine, such as the kiln system's preference for warm temperatures or for producing calcined coke with a specific RD range. The initial configuration of the kiln management engine may be based on data for several monitored system data categories, each of which may include one or more specific monitored system data category data values, each of which may have any suitable initial weight associated therewith, based on the information available to the model custodian at the time of initial configuration of the engine (e.g., at operation 402 of process 400 of FIG. 4). As an example, a monitored system data category may be kiln speed, and the various specific monitored system data category data values for that monitored system data category may include <40 rotations per hour, 40-45 rotations per hour, 45-50 rotations per hour, 50-55 rotations per hour, 55-60 rotations per hour, 60-65 rotations per hour, 65-70 rotations per hour, and >70 rotations per hour, each of which may have a particular initial weight associated with it.

FIG. 3 shows a schematic view of a kiln management system 301 of system 1 that may be provided to manage kiln variables of a kiln (e.g., to determine a kiln output product state of a kiln variable monitoring apparatus 103 and to manage a mode of operation of kiln variable monitoring apparatus 103 and/or of any other suitable subsystem of system 1 based on the determined kiln output product state). Kiln management system 301 may use various types of data accessible to system 1 in order to determine a current kiln output product state of a kiln in a particular kiln experience (e.g., in conjunction with model 19m), such as any suitable data provided by one or more MC modules of kiln apparatus monitoring subsystem 102 (e.g., any suitable kiln apparatus monitoring data 100a from one or more MC modules of subsystem 102 (e.g., data indicative of kiln rotation speed variable 130v, data indicative of natural gas flow rate variable 134v, and/or the like)), certain data provided by one or more MC modules of kiln material monitoring subsystem 104 (e.g., certain kiln material monitoring data 100m from one or more MC modules of subsystem 104 (e.g., data indicative of raw feed material quality variable 158v)), any suitable data provided by one or more MC modules of external environment monitoring subsystem 106 (e.g., any suitable external environment monitoring data 100e from one or more MC modules of subsystem 106 (e.g., data indicative of ambient humidity variable 160v, data indicative of ambient temperature variable 162v, and/or the like)), and/or the like. In response to determining/predicting the kiln output product state for a kiln experience, kiln management system 301 may apply at least one kiln management-based mode of operation to at least one managed element 390 (e.g., any suitable assembly of system 1) based on the determined kiln output product state (e.g., to suggest certain operator behavior and/or to control the functionality of one or more system assemblies) for improving the kiln system experience. For example, as shown in FIG. 3, kiln management system 301 may include a kiln output module 340 and a management module 380.

Kiln output module 340 of kiln management system 301 may be configured to use various types of accessible data in order to determine (e.g., characterize) a kiln output product state (e.g., a current kiln output product state of a kiln system in a current kiln experience). As shown, module 340 may be configured to receive any suitable kiln apparatus monitoring data 100a that may be generated and shared by subsystem 102 based on any monitored kiln apparatus variable(s) (e.g., automatically or in response to any suitable request data 100a′ that may be provided to subsystem 102 by module 340), any suitable kiln material monitoring data 100m that may be generated and shared by subsystem 104 based on any monitored kiln material variable(s) (e.g., automatically or in response to any suitable request data 100m′ that may be provided to subsystem 104 by module 340), and/or any suitable external environment monitoring data 100e that may be generated and shared by subsystem 106 based on any monitored external environment variable(s) (e.g., automatically or in response to any suitable request data 100e′ that may be provided to subsystem 106 by module 340), and module 340 may be operative to use such received data in any suitable manner in conjunction with any suitable kiln management model 19m to determine any suitable kiln output product state (e.g., with kiln management model data 100d that may be any suitable portion or the entirety of kiln management model 19m, which may be accessed automatically and/or in response to any suitable request data 100d′ that may be provided to model 19m by module 340, which may include any of the other data 100a/100m/100e received by module 340 (e.g., for use as inputs to the model)).

Once kiln output module 340 has determined a kiln output product state for a kiln experience (e.g., based on any suitable combination of one or more of any suitable received data 100a, 100m, 100e, and 100d), kiln output module 340 may be configured to generate and transmit kiln output product state data 322 to management module 380, where kiln output product state data 322 may be indicative of the determined kiln output product state for the kiln in the kiln experience. In response to determining a kiln output product state by receiving kiln output product state data 322, management module 380 may be configured to apply at least one kiln management-based mode of operation to at least one managed element 390 of system 1 based on the determined kiln output product state. For example, as shown in FIG. 3, kiln management system 301 may include management module 380, which may be configured to receive kiln output product state data 322 from kiln output module 340, as well as to generate and share kiln management mode data 324 with at least one managed element 390 of system 1 at least partially based on the received kiln output product state data 322, where such kiln management mode data 324 may be received by managed element 390 for controlling at least one characteristic of managed element 390. Managed element 390 may be any suitable assembly of system 1 (e.g., any processor assembly 12, any memory assembly 13 and/or any data stored thereon, any communications assembly 14, any power supply assembly 17, any I/O assembly 16, any sensor assembly 15, etc.) of any suitable subsystem (e.g., any MC module of subsystem 102, 104, and/or 106 and/or any I/O assembly of subsystem 112 and/or 119), and kiln management mode data 324 may control managed element 390 in any suitable way, such as by enhancing, enabling, disabling, restricting, adjusting, and/or limiting one or more certain functionalities associated with such a managed element.

Kiln management mode data 324 may be any suitable controlling data for controlling any suitable functionality of any suitable assembly of system 1 as a managed element 390 (e.g., any suitable output control data for controlling any suitable functionality of any suitable output assembly of an I/O assembly 16 of any subsystem (e.g., for adjusting a user interface presentation to an operator 109 (e.g., to provide a suggestion or a predicted kiln output product state) and/or for adjusting any valve or actuator or other suitable MC module of subsystem 102/104/106 (e.g., for adjusting operation of kiln 107 or a characteristic of its feed material 121 or of its ambient environment 115) and/or for controlling any suitable functionality of any suitable sensor assembly 15 of any suitable subsystem (e.g., for turning on or off a particular type of sensor and/or for adjusting the functionality (e.g., the accuracy) of a particular type of sensor (e.g., to gather any additional suitable sensor data)), and/or the like)).

Additionally or alternatively, kiln management mode data 324 may be any suitable kiln management model update data (e.g., an update type of kiln management model request data 100d′) for providing any suitable data to kiln management model 19m as a managed element 390 (e.g., any suitable kiln management model request data 100d′ for updating kiln management model 19m in any suitable manner).

FIG. 4 is a flowchart of an illustrative process 400 for managing a kiln. At operation 402 of process 400, a kiln management model custodian (e.g., a kiln management model custodian system) may initially configure a learning engine (e.g., kiln management model 19m) for a kiln system. At operation 404 of process 400, the kiln management model custodian may receive, from the kiln system, monitored system data for at least one monitored system data category for a kiln experience and a kiln output product state for the kiln experience.

At operation 406 of process 400, the kiln management model custodian may train the learning engine using the received monitored system data and the received kiln output product state. At operation 408 of process 400, the kiln management model custodian may access monitored system data for the at least one monitored system data category for another kiln experience. At operation 410 of process 400, the kiln management model custodian may determine a kiln output product state, using the learning engine, with the accessed monitored system data for the other kiln experience. At operation 412 of process 400, when the determined kiln output product state for the kiln experience satisfies a condition, the kiln management model custodian may generate control data associated with the satisfied condition.

It is understood that the operations shown in process 400 of FIG. 4 are only illustrative and that existing operations may be modified or omitted, additional operations may be added, and the order of certain operations may be altered.

The use of one or more suitable models or engines or neural networks or the like (e.g., kiln management model 19m) may enable prediction or any suitable determination of a kiln output product state of a kiln in a kiln experience. Such models (e.g., neural networks) running on any suitable processing units (e.g., graphical processing units (“GPUs”) that may be available to system 1) provide significant speed improvements in efficiency and accuracy with respect to prediction over other types of algorithms and human-conducted analysis of data, as such models can provide estimates in a few milliseconds or less, thereby improving the functionality of any computing device on which they may be run. Due to such efficiency and accuracy, such models enable a technical solution for enabling the generation of any suitable control data (e.g., for controlling any suitable functionality of any suitable managed element (e.g., output assembly, actuator, valve, sensor, etc.) using any suitable real-time data (e.g., data made available to the models) that may not be possible without the use of such models, as such models may increase performance of their computing device(s) by requiring less memory, providing faster response times, and/or increased accuracy and/or reliability. Due to the condensed time frame and/or the time within which a decision with respect to monitored kiln system data ought to be made to provide a desirable kiln use experience, such models offer the unique ability to provide accurate determinations with the speed necessary to enable effective and efficient kiln use management.

The methodology described herein with respect to kiln system 1 and kiln management system 301 (e.g., “SmartKiln” methodology) may be configured to use a wide range of expertise and technology selected and assembled by engineering and automation professionals, including AI and ML, to autonomously operate a kiln, while optimizing the quality of the finished product (e.g., calcined material). Using IoT functionality, thousands of data points may be collected from various sensors, thermocouples, meters, devices, and any other suitable MC modules. This information may be sent to a specially trained kiln management model (e.g., on-site software) that may in turn use highly capable automation hardware and custom logic to intelligently control the kiln. Each one of various different calcining kilns may be individually tuned for optimized operation (e.g., through dedicated human resources, highly developed automation hardware, controls logic, and/or iterative model development). When purchasing products made using such methodology and technology, customers can expect the very best quality at the very best price. Instead of receiving product produced under the control of one or two operators, they can receive product that has been produced by the collective knowledge of potentially every operator over a long period of time, further optimized by engineering, automation, and quality staff who may continually fine-tune the methodology.

Commissioning such a methodology may include a one-time activity to configure AI software to operate a kiln, which may involve a series of activities, such as configuring data flow, confirming connectivity and feeds. After commissioning, a model may be utilized to predict behavior (e.g., a kiln output product state) and recommend actions (e.g., generate control data), but the controller may be in open loop and may not be permitted to actually make changes to the kiln functionality. While later, when in closed loop (e.g., “model engaged”), the model may be actively monitoring and controlling the kiln. In order for the model to be engaged, certain criteria may first be made available as conditional availability (e.g., access to the DataFeed or specific data, such as feed rate or burn zone temperature). Without these, the DLPC (e.g., of kiln model server 114) would not be able to effectively control the kiln. One or more operational bounds may be defined, such as pre-defined upper/lower control limits for a variable (e.g., both manipulated and controlled). The model may be configured to honor the bounds of a manipulated variable and may be configured to disengage if violating the bounds of a controlled variable. Such operational bounds may also be referred to as collars or limits. The DLPC may be configured to compare predicted inferential values (e.g., RD) of any suitable predicted kiln output product state with the actual value (e.g., when it may be later discovered (e.g., via laboratory testing on material 145 for variable 147v and/or variable 148v). If the discovered difference is large, the DLPC may be configured to learn and apply a “bias” to the next predicted value (e.g., at module 340), where the greater the discovered difference, the greater the applied bias. For example, bias may be used to modify a predicted value of calcined material ER variable 147v and/or calcined material RD variable 148v (e.g., the IVs). As a simple example for explanation purposes only, assume we set an oven to 350° F. to bake a cake, the oven reads 350° F., but every time we make a cake, it's raw and undercooked, so we start adjusting the temperature to 360° F. and now, the cake is only a little underdone, so we tweak it to 365° F., and we get a perfect cake, therefore, whether the temperature is actually 365° F. or the reading on the oven is wrong, it doesn't really matter, we've applied a bias and it works for the situation. It can also use an average of several results to smooth the effect of the bias. In some embodiments, a model (e.g., a model's weights, etc.) may not be updated on the fly (e.g., during use of the model for managing a kiln), but may be retrained at certain down times with certain additional training data for improving the model. However, in such embodiments, bias may be applied on the fly (e.g., during use of the model for managing a kiln), such that a model's reaction may still change (e.g., what a model is controlling to may slightly move based on recent lab samples (e.g., inferential equation may be used to predict what lab values will be (e.g., 95% old and 5% bias to get as close as possible to actual values))). Therefore, a model custodian may be configured to receive long time historical monitored system data for a kiln and use that data to train a kiln model, such that it may discover relationships on the historical data (e.g., this is what the kin output product state (e.g., RD) may be for a set of given conditions (e.g., apparatus and/or environment variables) and may then make adjustments in real time to attempt to achieve certain results (e.g., predicts, given current conditions, how a product will result based on certain conditions and then adds bias to correct previous predictions).

The system may be configured to have any suitable step/rate bound(s) (e.g., the maximum amount of change the DLC may be permitted to make during a given time period). For example, DLPC may be configured to generate control data for increasing natural gas flow by 100%, but, instead of allowing this change to happen immediately, a step/rate bound of the system may be configured to only allow it to change 5% every 10 minutes or any other suitable limited change. Different entities may be responsible for different aspects of the systems and/or methodologies described herein. For example, an informational technology (“IT”) team may include network engineers who may be responsible for network communications both internally and externally (e.g., with the outside), management/monitoring of switches and servers, user access, licensing, firewalls, communications in/out/between devices, and/or the like. As another example, an operations technology (“OT”) may include persons who may be responsible for the automation network, including, but not limited to, processors, controls software (e.g., any suitable software, including that which may be provided by Rockwell, Schneider, etc.), automation logic (e.g., PIDs, interlocks, etc.), HNIIs (e.g., interfaces with end users (e.g., operators)), historian tags/storage, backups of automation programs, and/or the like.

A kiln management model custodian system may be configured to achieve any suitable goals for a managed kiln system, including, but not limited to, the ability to control real density of a calcined product of the kiln system (e.g., variable 148v), the ability to control electrical resistivity of a calcined product of the kiln system (e.g., variable 147v), the ability to minimize the consumption of natural gas by the kiln system (e.g., variable 134v), the ability to control burn zone temperature (e.g., variable 132v), the ability to minimize material loss of the system (e.g., yield, which may be a calculated value that can be fed from subsystem 119 based on the raw scale weights, the raw moisture value, and/or the calcined scale weights, where there may be known to be an inverse relationship between RD and yield, whereby if a system can toe the line on the RD, material loss may be minimized), the ability to reduce standard deviation (e.g., in product consistency) to improve product consistency (e.g., for calcined material 145 produced by the kiln system), the ability to minimize real density giveaway (e.g., the measurement of difference between an entity's (e.g., customer's) minimum specification for the real density of the calcined material to be produced and the actual real density of the calcined material produced by the kiln system (e.g., because real density tends to correlate with lower yield, real density giveaway is to be minimized)), and/or the like. A kiln model may be told what a target may be for a product to be produced by the kiln (e.g., a target RD value of the calcined material) so that the model may be configured to set characteristics for optimal kiln control (e.g., lowest temperature, lowest natural gas use, etc. (e.g., such that operation of the kiln may be less expensive) or for any other optimal results). Kiln model server 114 may be configured to use historical data and relationships to determine optimal conditions for hitting an RD target while staying within any bounds and minimizing fuel. It may be configured to then send those settings to the gateway where the controls system may be configured to take actions set by kiln model server 114.

It is to be understood that the more historical data that may be available (e.g., for training a model), the more relationships between variables may be revealed (e.g., there might be a very strong relationship between burn zone temperature and stack damper position that may be realized through training with certain historical data, but if the damper position has never been changed, there is no way for historical data training to enable discovery of the relationship or how that relationship may behave). There may be other influences on model inputs. For example, some kiln system locations may produce calcined material with kiln output product states that have a vast specification difference. Instead of coding this difference in the software, a raw feed quality (e.g., Vanadium percentage) may be used as a method of indicating a blend, such that when a model may receive monitored system data indicative of a feed with a high percentage of Vanadium (e.g., by variable 158v), the model may be run accordingly (e.g., this may be considered a mutated variable, where the Vanadium may be multiplied by the feed rate, where a goal may be to get the information into the model for Vanadium, and where the model may not be configured or otherwise able to handle large step changes very well, so that if Vanadium was fed in with no “mutation,” it may be a step change signal, whereas this may smooth out the Vanadium signal and give it some real-time process movement). Additionally or alternatively, each kiln system location may have its own environmental requirements, and, as such, certain monitored system data may be provided from additional devices or MC modules to ensure those environmental requirements may be met (e.g., stack opacity monitoring module(s) 156m).

One, some, or all of the processes described with respect to FIGS. 1-4 may each be partially or entirely implemented by software, but may also be implemented in hardware, firmware, or any combination of software, hardware, and firmware. Instructions for performing these processes may also be embodied as machine- or computer-readable code recorded on a machine- or computer-readable medium. In some embodiments, the computer-readable medium may be a non-transitory computer-readable medium. Examples of such a non-transitory computer-readable medium include but are not limited to a read-only memory, a random-access memory, a flash memory, a CD-ROM, a DVD, a magnetic tape, a removable memory card, and a data storage device (e.g., memory 13 of FIG. 1A). In other embodiments, the computer-readable medium may be a transitory computer-readable medium. In such embodiments, the transitory computer-readable medium can be distributed over network-coupled computer systems so that the computer-readable code is stored and executed in a distributed fashion. For example, such a transitory computer-readable medium may be communicated from a KVMS subsystem to a monitoring subsystem, from a monitoring subsystem to a KVMS subsystem, and/or from any suitable subsystem to any other suitable subsystem using any suitable communications protocol (e.g., the computer-readable medium may be communicated to a subsystem as at least a portion of an application 19 via any suitable communications components and/or via any suitable network(s) 101). Such a transitory computer-readable medium may embody computer-readable code, instructions, data structures, program modules, or other data in a modulated data signal, such as a carrier wave or other transport mechanism, and may include any information delivery media. A modulated data signal may be a signal that has one or more of its characteristics set or changed in such a manner as to encode information in the signal.

Any, each, or at least one module or component or subsystem of the disclosure may be provided as a software construct, firmware construct, one or more hardware components, or a combination thereof. For example, any, each, or at least one module or component or subsystem of system 1 may be described in the general context of computer-executable instructions, such as program modules, that may be executed by one or more computers or other devices. Generally, a program module may include one or more routines, programs, objects, components, and/or data structures that may perform one or more particular tasks or that may implement one or more particular abstract data types. The number, configuration, functionality, and interconnection of the modules and components and subsystems of system 1 are only illustrative, and that the number, configuration, functionality, and interconnection of existing modules, components, and/or subsystems may be modified or omitted, additional modules, components, and/or subsystems may be added, and the interconnection of certain modules, components, and/or subsystems may be altered.

Implementations within the scope of the present disclosure can be partially or entirely realized using a tangible computer-readable storage medium, or multiple tangible computer-readable storage media of one or more types, encoding one or more instructions. The tangible computer-readable storage medium also can be non-transitory in nature.

At least a portion of one or more of the modules of management system 301 may be stored in or otherwise accessible to a subsystem (e.g., subsystem 108) in any suitable manner (e.g., in memory assembly 13 (e.g., as at least a portion of application 19)). Any or each module of management system 301 may be implemented using any suitable technologies (e.g., as one or more integrated circuit devices), and different modules may or may not be identical in structure, capabilities, and operation. Any or all of the modules or other components of management system 301 may be mounted on an expansion card, mounted directly on a system motherboard, or integrated into a system chipset component (e.g., into a “north bridge” chip).

Any or each module of management system 301 may be a dedicated system implemented using one or more expansion cards adapted for various bus standards. For example, all of the modules may be mounted on different interconnected expansion cards or all of the modules may be mounted on one expansion card. With respect to management system 301, by way of example only, the modules of management system 301 may interface with a motherboard or processor assembly 12 (e.g., of subsystem 108) through an expansion slot (e.g., a peripheral component interconnect (“PCI”) slot or a PCI express slot). Alternatively, management system 301 need not be removable but may include one or more dedicated modules that may include memory (e.g., RAM) dedicated to the utilization of the module. In other embodiments, management system 301 may be at least partially integrated into a subsystem (e.g., subsystem 108 (e.g., server 114)). For example, a module of management system 301 may utilize a portion of memory assembly 13 of the subsystem. Any or each module of management system 301 may include its own processing circuitry and/or memory. Alternatively, any or each module of management system 301 may share processing circuitry and/or memory with any other module of management system 301 and/or processor assembly 12 and/or memory assembly 13 of the subsystem (e.g., subsystem 108 (e.g., server 114)).

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory. FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device (e.g., via one or more wired connections, one or more wireless connections, or any combination thereof).

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data Computer-executable instructions also can be organized in any format, including, but not limited to, routines, subroutines, programs, data structures, objects, modules, applications, applets, functions, and/or the like. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations may be performed by one or more integrated circuits, such as ASICs or FPGAs. In one or more implementations, such integrated circuits may execute instructions that may be stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software may depend upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used in this specification and any claims of this application, the terms “base station,” “receiver,” “computer,” “server,” “processor,” and “memory” may all refer to electronic or other technological devices. These terms exclude people or groups of people. For the purposes of the specification, the terms “display” or “displaying” means displaying on an electronic device.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. The term “and/or” as used herein refers to and encompasses any and all possible combinations of one or more of the associated listed items. As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” may each refer to only A, only B, or only C; any combination of A, B, and C; and/or at least one of each of A, B, and C. The terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

As used herein, the terms “computer,” “personal computer,” “device,” and “computing device” may refer to any programmable computer system that is known or that will be developed in the future. In certain embodiments, a computer will be coupled to a network, such as described herein. A computer system may be configured with processor-executable software instructions to perform the processes described herein. Such computing devices may be mobile devices, such as a mobile telephone, data assistant, tablet computer, or other such mobile devices. Alternatively, such computing devices may not be mobile (e.g., in at least certain use cases), such as in the case of server computers, desktop computing systems, or systems integrated with non-mobile components.

As used herein, the terms “component,” “module,” and “system,” are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server may be a component. One or more components may reside within a process and/or thread of execution and a component may be localized on one computer and/or distributed between two or more computers.

The predicate words “configured to,” “operable to,” and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation.

Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the an are expressly incorporated herein by reference and are intended to be encompassed by the claims. Moreover, nothing disclosed herein is intended to be dedicated to the public regardless of whether such disclosure is explicitly recited in the claims No claim element is to be construed under the provisions of 35 U.S.C. § 112, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter/neutral gender (e.g., her and its and they) and vice versa. Headings and subheadings, if any, are used for convenience only and do not limit the subject disclosure. It is also to be understood that various directional and orientational terms, such as “up” and “down,” “left” and “right,” “forward” and “back,” “edge” and “corner,” “top” and “bottom” and “side,” “above” and “below,” “length” and “width” and “thickness” and “diameter” and “cross-section” and “longitudinal,” “X-” and “Y-” and “Z-,” “roll” and “pitch” and “yaw,” “clockwise” and “counter-clockwise,” and/or the like, may be used herein only for convenience, and that no fixed or absolute directional or orientational limitations are intended by the use of these terms. For example, the components of the system can have any desired orientation. If reoriented, different directional or orientational terms may need to be used in their description, but that will not alter their fundamental nature as within the scope and spirit of the subject matter described herein in any way.

While there have been described systems, methods, and computer-readable media for managing variables of a kiln, many changes may be made therein without departing from the spirit and scope of the subject matter described herein in any way. Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

Therefore, those skilled in the art will appreciate that the concepts of the disclosure can be practiced by other than the described embodiments, which are presented for purposes of illustration rather than of limitation.

What is claimed is:

1. A method for managing a kiln system using a kiln management model custodian system, the method comprising:
initially configuring, at the kiln management model custodian system, a learning engine for the kiln system;
receiving, at the kiln management model custodian system from the kiln system, monitored system data for at least one monitored system data category for a kiln experience and a kiln output product state for the kiln experience;
training, at the kiln management model custodian system, the learning engine using the received monitored system data and the received kiln output product state;
accessing, at the kiln management model custodian system, monitored system data for the at least one monitored system data category for another kiln experience;
determining a kiln output product state for the other kiln experience, using the learning engine for the kiln system at the kiln management model custodian system, with the accessed monitored system data for the other kiln experience; and
when the determined kiln output product state for the other kiln experience satisfies a condition, generating, with the kiln management model custodian system, control data associated with the satisfied condition.

2. The method of claim 1, wherein the at least one monitored system data category comprises kiln rotation speed.

3. The method of claim 1, wherein the at least one monitored system data category comprises burn zone temperature.

4. The method of claim 1, wherein the at least one monitored system data category comprises air flow rate.

5. The method of claim 1, wherein the at least one monitored system data category comprises fuel flow rate.

6. The method of claim 1, wherein the control data is operative to provide a recommendation to adjust a control variable of the kiln system.

7. The method of claim 1, wherein the control data is operative to automatically adjust a control variable of the kiln system.

8. The method of claim 1, wherein the control data is operative to provide a recommendation to adjust a temperature of the kiln system.

9. The method of claim 1, wherein the control data is operative to automatically adjust a temperature of the kiln system.

10. The method of claim 1, wherein the control data is operative to provide a recommendation to adjust a kiln rotation speed of the kiln system.

11. The method of claim 1, wherein the control data is operative to automatically adjust a kiln rotation speed of the kiln system.

12. The method of claim 1, wherein the control data is operative to automatically adjust a functionality of a computing device of the kiln system.

13. The method of claim 1, wherein the determined kiln output product state for the other kiln experience comprises a value of electrical resistivity of a calcined material of the kiln system.

14. The method of claim 1, wherein the determined kiln output product state for the other kiln experience comprises a value of real density of a calcined material of the kiln system.

15. The method of claim 1, wherein the determined kiln output product state for the other kiln experience comprises:
a value of electrical resistivity of a calcined material of the kiln system; and
a value of real density of a calcined material of the kiln system.

16. A kiln management model custodian system comprising:
a communications component; and
a processor operative to:
initially configure a learning engine for the kiln system;
receive, from the kiln system, monitored system data for at least one monitored system data category for a kiln experience and a kiln output product state for the kiln experience;
train the learning engine using the received monitored system data and the received kiln output product state;
access monitored system data for the at least one monitored system data category for another kiln experience;
determine a kiln output product state for the other kiln experience, using the learning engine for the kiln system, with the accessed monitored system data for the other kiln experience; and
when the determined kiln output product state for the other kiln experience satisfies a condition, generate control data associated with the satisfied condition.

17. A non-transitory computer-readable storage medium storing at least one program comprising instructions, which, when executed:
initially configure a learning engine for a kiln system;
receive, from the kiln system, monitored system data for at least one monitored system data category for a kiln experience and a kiln output product state for the kiln experience;
train the learning engine using the received monitored system data and the received kiln output product state;
access monitored system data for the at least one monitored system data category for another kiln experience;
determine a kiln output product state for the other kiln experience, using the learning engine for the kiln system, with the accessed monitored system data for the other kiln experience; and
when the determined kiln output product state for the other kiln experience satisfies a condition, generate control data associated with the satisfied condition.
